(19) United States
(12) Patent Application Publication
(10) Pub. No.: US 2024/0076915 A1
(43) Pub. Date: Mar. 7, 2024

(54) VEHICULAR CLOSURE OPENING DEVICE WITH PUSH TO ACTUATE FUNCTION

(71) Applicant: Magna Mirrors of America, Inc., Holland, MI (US)

(72) Inventors: Anthony J. LaCross, Hastings, MI (US); Connor G. Cervone, Byron Center, MI (US); Justin E. Sobecki, Rockford, MI (US); Nathan C. Shipaila, Rockford, MI (US)

(21) Appl. No.: 18/457,480

(22) Filed: Aug. 29, 2023

Related U.S. Application Data
(60) Provisional application No. 63/509,374, filed on Jun. 21, 2023.
(60) Provisional application No. 63/373,870, filed on Aug. 30, 2022.

(51) Int. Cl. E05B 85/10; E05B 81/04; E05B 85/16

(52) U.S. Cl. CPC E05B 85/107; E05B 81/04; E05B 85/16; E05Y 2900/531

(57) ABSTRACT

A vehicular exterior door handle assembly includes a base, a handle, and a deployment mechanism operable to move the handle between a recessed position and a deployed position. The deployment mechanism includes a return cam biased in a first direction relative to the base. The deployment mechanism, with the handle in the recessed position, secures the return cam relative to the base. The handle is manually movable beyond the recessed position away from the deployed position to actuate the deployment mechanism. The deployment mechanism, responsive to being actuated, releases the return cam and the return cam moves in the first direction to move the handle toward the deployed position. The handle is manually movable beyond the deployed position away from the recessed position to actuate a latch of the door. The deployment mechanism, responsive to the handle actuating the latch, moves the handle toward the recessed position.

### CROSS REFERENCE TO RELATED APPLICATIONS

The present application claims the filing benefits of U.S. provisional application Ser. No. 63/509,374, filed Jun. 21, 2023, and U.S. provisional application Ser. No. 63/373,870, filed Aug. 30, 2022, which are hereby incorporated herein by reference in their entireties.

### FIELD OF THE INVENTION

The present invention relates to handles for vehicles and, more particularly, to an exterior handle for opening a side door and/or liftgate of a vehicle.

### BACKGROUND OF THE INVENTION

A door handle for a vehicle door typically includes a handle portion that is pivotable relative to a base portion, whereby pivotal movement of the handle portion actuates a latch mechanism to open the door. Typically, a door handle is a pull strap handle with a strap handle portion that protrudes outwardly from the side of the vehicle for grasping by the person opening the door of the vehicle. Alternately, paddle type door handle assemblies are known, where a paddle portion is pivotally mounted to a base portion and is pulled generally outwardly and upwardly to open the vehicle door.

### SUMMARY OF THE INVENTION

An extendable flush door handle assembly for opening a door of a vehicle (such as a side door or rear door or liftgate of a vehicle) includes a handle portion that is disposed at the door such that, when not in use to open the vehicle door, the handle portion is recessed at the door, with the outer surface of the handle portion generally flush with or generally coplanar with (or only slightly protruding from or slightly recessed in) the outer surface of the door panel at the door handle region of the door. The door handle assembly is operable to deploy or extend or move or pivot the handle portion outward from the door panel when a user is to use the handle to open the vehicle door, such as in response to an input or force received at the handle portion that at least partially depresses or pivots the handle portion inward toward the door panel. When so deployed or extended or moved to a deployed position, the handle may be readily grasped by the user and actuated or pulled or moved further outward to open the vehicle door. After the user releases the handle, the handle may return to its non-use or partially recessed position where its outer surface is generally flush or coplanar with (or only slightly protruding from of recessed in) the outer surface of the door panel.

Optionally, a vehicular exterior door handle assembly includes a base portion configured to mount at a door of a vehicle and a handle portion that includes a grasping portion. The handle portion is movable relative to the base portion between (i) a recessed position, where the grasping portion of the handle portion is at least partially recessed at the base portion, and (ii) a deployed position, where the grasping portion of the handle portion protrudes outward from the base portion so as to be graspable by a user. A deployment mechanism is coupled to the handle portion and operable to move the handle portion between the recessed position and the deployed position. The handle portion, when in the recessed position, is manually movable beyond the recessed position and further from the deployed position to actuate the deployment mechanism. The deployment mechanism, with the handle portion in the recessed position and responsive to the handle portion being moved beyond the recessed position, operates to move the handle portion toward the deployed position. The handle portion, when in the deployed position, is manually movable beyond the deployed position and further from the recessed position to actuate a latch mechanism of the door. The deployment mechanism, with the handle portion in the deployed position and responsive to the handle portion being moved beyond the deployed position, operates to move the handle portion toward the recessed position.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with an extendable flush door handle assembly;

FIG. 2 is an enlarged perspective view of the extendable flush door handle assembly at the vehicle door, with the door handle in its flush or non-use or recessed position;

FIGS. 3 and 4 are perspective views of the door handle assembly with the handle portion in the recessed position relative to the base portion;

FIGS. 5 and 6 are perspective views of the handle portion and deployment mechanism of the door handle assembly;

FIG. 7 is an exploded view of the door handle assembly;

FIGS. 8 and 9 are plan views of the door handle assembly with the handle portion in the recessed position relative to the base portion;

FIG. 10 is a plan view of the handle portion and deployment mechanism of the door handle assembly;

FIGS. 11-15 are enlarged plan views of the deployment mechanism as the deployment mechanism operates to move the handle from the recessed position toward the deployed position;

FIGS. 16-19 are enlarged plan views of the handle return cam of the deployment mechanism, lever or protrusion of the handle portion, and cable pull cam coupled to the door latch mechanism as the deployment mechanism operates to move the handle from the recessed position toward the deployed position;

FIGS. 20A-20E are views of the door handle assembly and deployment mechanism with the handle portion in a depressed or actuated position where the handle portion is pressed into the base portion beyond the recessed position to actuate the deployment mechanism;

FIGS. 21A-21E are views of the door handle assembly and deployment mechanism with the handle portion in the deployed position;

FIGS. 22A-22E are views of the door handle assembly and deployment mechanism with the handle portion moved beyond the deployed position toward or to the extended position to actuate the door latch mechanism;

FIGS. 23A-23E are views of the door handle assembly and deployment mechanism with the handle portion between the deployed position and the recessed position after the handle portion has been moved to and released from the extended position;

FIGS. 24A-24E are views of the door handle assembly and deployment mechanism with the handle portion between the deployed position and the recessed position while the handle portion is being manually returned from the deployed position without being moved to the extended position;

FIG. 25 is an exploded view of another door handle assembly;

FIGS. 26A-26F are perspective views of the door handle assembly of FIG. 25 as the handle portion is moved between the flush position, the recessed position, the deployed position and the extended position;

FIGS. 27A-27E are views of the latch release mechanism of the door handle assembly of FIG. 25 as the handle portion is moved between the flush position, the recessed position, the deployed position and the extended position;

FIGS. 28-30 are views of the door handle assembly of FIG. 25, showing the deployment latch disengaged from the latch release mechanism;

FIG. 30A is an enlarged view of portion A in FIG. 30;

FIGS. 31A-31C are views of the latch release mechanism and the deployment latch of the door handle assembly of FIG. 25 as the handle portion is moved between the flush position and the deployed position;

FIGS. 32A and 32B are views of the handle return cam and the latch release mechanism of the door handle assembly of FIG. 25 as the handle is depressed to deploy the handle;

FIGS. 33A-33D are views of the handle return cam, the latch release mechanism and the deployment latch of the door handle assembly of FIG. 25 as the handle portion is moved between the flush position and the extended position;

FIG. 34A is a view of the handle return cam and the cable pull cam of the door handle assembly of FIG. 25, with respective biasing members at the handle return cam and the cable pull cam in unwound states;

FIGS. 34B and 34C are views of the handle return cam and the cable pull cam of the door handle assembly of FIG. 25, with the biasing member at the handle return cam in a wound state and the biasing member at the cable pull cam in an unwound state;

FIG. 35 is a view of the latch release mechanism of the door handle assembly of FIG. 25 before being installed at the base portion;

FIGS. 36-38 are views of the latch release mechanism of the door handle assembly of FIG. 25 after being installed at the base portion;

FIGS. 39 and 40 are views of an electronic latch mechanism of the door handle assembly of FIG. 25, with the electronic trigger positioned at the base portion near the cable pull cam;

FIG. 41 is a view of the electronic latch mechanism of the door handle assembly of FIG. 25, with the electronic trigger positioned at the base portion near the inner side of the handle at the end of the handle that pivots toward the base portion when moved further beyond the deployed position; and

FIG. 42 is a view of the electronic latch mechanism of the door handle assembly of FIG. 25, with the electronic trigger positioned at the base portion near the inner side of the handle at the end of the handle that moves toward the base portion when the handle is depressed to deploy the handle.

### DESCRIPTION OF THE PREFERRED EMBODIMENTS

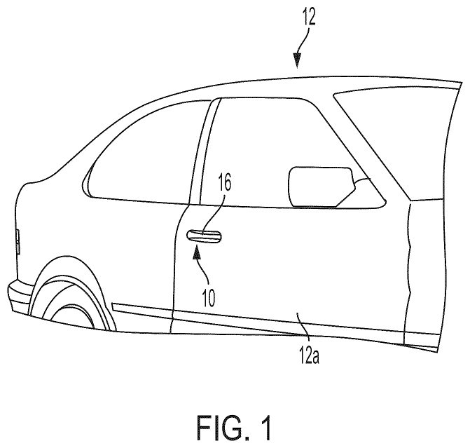

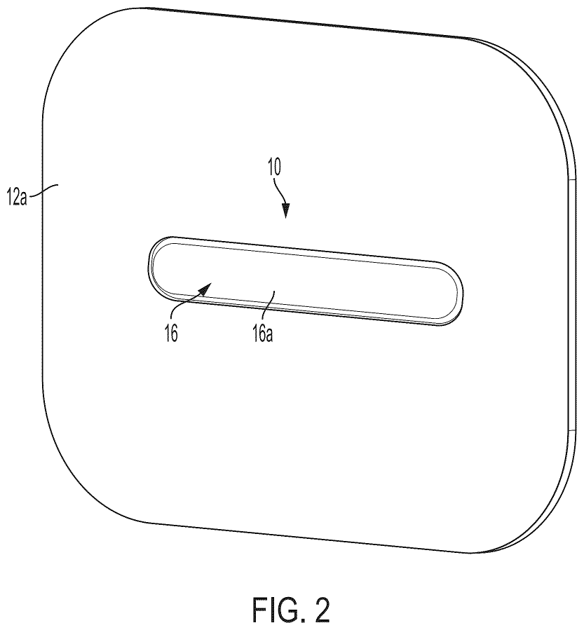

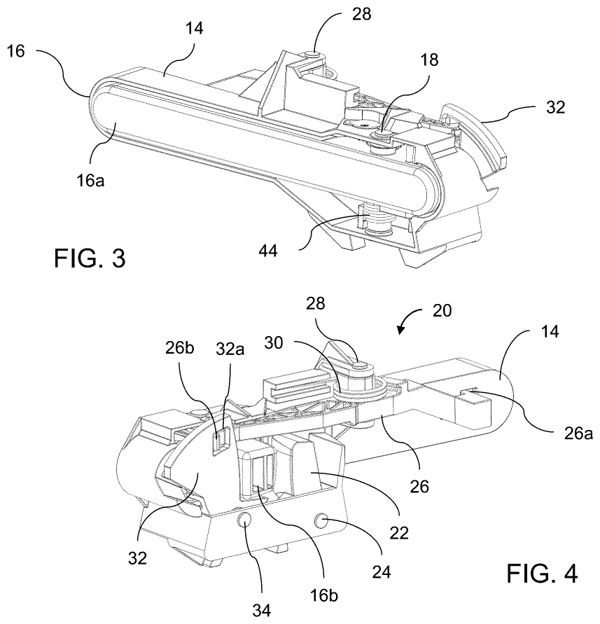

Referring now to the drawings and the illustrative embodiments depicted therein, a vehicular handle assembly or module or unit or extendable flush door handle assembly 10 is mountable to a door 12a of a vehicle 12 and operable to release a latch mechanism of the vehicle door 12a to open the vehicle door (FIGS. 1 and 2). The vehicular handle assembly 10 includes a base portion or bracket 14 that is mountable to the vehicle door 12a and a handle or strap portion 16 that is movably or pivotally mounted to the bracket 14 (FIG. 3). When not in use, the handle portion 16 is at an initial rest or recessed or non-use position and is received or disposed at or partially in the base portion 14 so that an outer surface 16a of the handle portion 16 is generally flush with or generally coplanar with (or protruding only slightly from or recessed slightly from) the outer surface 14a of the base portion 14 or the door panel 12a, whereby the handle portion 16 is not readily graspable by a user (FIG. 2). The handle portion 16 is mechanically pivotable or movable or laterally movable relative to the door and the base portion 14 to move to its deployed or ready or operational or grippable or graspable or person-operable position and is then graspable or grippable by a user where the handle portion 16 may be manually moved (such as via pulling by the user) further from the non-use position to actuate a bellcrank at the base portion 14, which in turn actuates or releases the latch mechanism of the door to open the vehicle door. The handle assembly 10 includes a push-to-actuate deployment mechanism 20 at the base portion 14 for imparting the movement of the handle portion 16 relative to the base portion 14 from the recessed position to the deployed or ready or graspable position. When the handle portion 16 is in the recessed position, and responsive to an input or force or push at the outer surface 16a of the handle portion 16 that at least partially depresses or pushes the handle portion 16 inward toward the door 12a relative to the base portion 14, the deployment mechanism 20 is operable to move the handle portion 16 from the recessed position to the deployed position. When in the deployed position, the handle portion 16 may be manually moved back toward the recessed position or, after the handle is pulled or further moved beyond the deployed position toward an extended position to open the door, the deployment mechanism 20 may automatically return the handle portion 16 to the recessed position.

The handle assembly 10 may comprise any suitable type of handle assembly, and may include or incorporate aspects of the door handle assemblies described in U.S. Pat. Nos. 8,786,401; 6,977,619; 7,407,203 and/or 8,333,492, and/or U.S. Publication Nos. US-2022-0018168; US-2022-0282534; US-2022-0341226 and/or US-2020/0102773, and/or U.S. patent application Ser. No. 18/359,114, filed Jul. 26, 2023 (Attorney Docket DON05 P4888), which are all hereby incorporated herein by reference in their entireties. Optionally, aspects of the handle assembly 10 and/or the deployment mechanism 20 may be suitable for use with a liftgate handle assembly for a liftgate or tailgate of a vehicle. Although shown and described as a deployment mechanism for pivoting the door handle, the deployment mechanism may be configured to cause lateral or non-pivoting movement of the handle portion 16 relative to the base portion 14.

As described further below, the deployment mechanism 20 and door handle assembly 10 provide an all-mechanical deployable flush door handle. The handle portion 16 deploys with the user's input of a push on the handle portion 16 and, once the handle portion 16 is deployed, the deployed handle is reset back to the flush or recessed state either with a push or a pull on the handle portion 16. For example, the handle portion 16 can be pulled all the way to an unlatch state or extended position to release a latch mechanism of the vehicle door and the handle portion 16 returns to the flush state when released from the extended position. Thus, the flush door handle is deployable from the flush state and returnable to the flush state from the deployed state without the use of an actuator or other electric or electromechanical motor or mechanism, which are commonly used with traditional flush door handle assemblies. A fully mechanical deployment mechanism may require less maintenance, be more reliable, and provide cost savings over door handle assemblies that rely on electrically operated actuators to deploy the door handle.

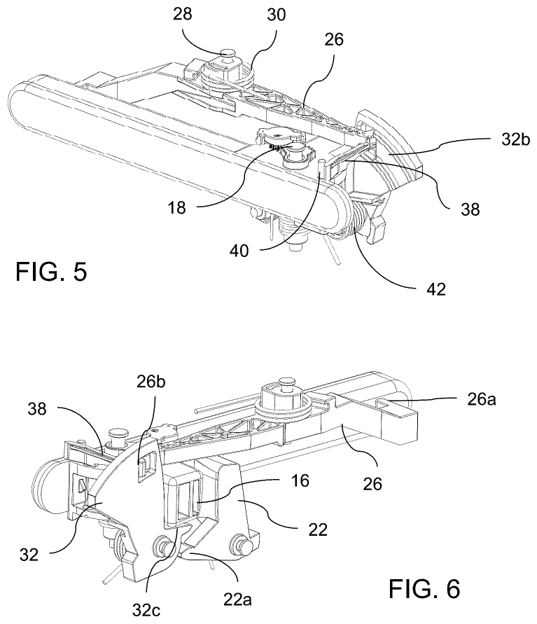

As shown in FIGS. 3-7, the handle portion 16 is pivotable relative to the base portion or bracket 14 that is configured to mount at the vehicle door. The base portion 14 defines a recess and, in the recessed or non-use position, the handle portion 16 is disposed at least partially within the recess of the base portion 14. In the illustrated embodiment, the handle portion 16 is pivotally attached to the base portion 14 via a pivot pin 18 that extends through the handle portion 16 and the base portion 14 to define a pivot axis of the handle portion 16. The handle portion 16 includes a protrusion or lever 16b that extends through the base portion 14 at a rear surface of the base portion 14.

A cable pull cam 22 is disposed behind the base portion 14 (i.e., at or behind the rear surface of the base portion) and is pivotally attached relative to the base portion 14 via a pivot pin 24. When the handle portion 16 is in the deployed position and is grasped by a user and moved further beyond the deployed position toward the extended position, the lever 16b pivots with the handle portion 16 and engages and acts upon the cable pull cam 22 that in turn actuates or releases the latch mechanism of the door. For example, the cable pull cam 22 may be coupled to the latch mechanism via a cable and when the handle portion 16 imparts pivotal movement of the cable pull cam 22, pivoting of the cable pull cam 22 pulls the cable to actuate the latch mechanism.

The deployment mechanism 20 is coupled to the base portion 14 and is disposed behind the base portion 14 within the door panel. Responsive to the input or push by the user, the deployment mechanism 20 imparts movement of the lever 16b to move the handle portion 16 from the recessed position toward the deployed position so that the lever 16b moves toward engagement with the cable pull cam 22 to impart movement of the cable pull cam 22 when the user grasps and pulls on the handle portion 16.

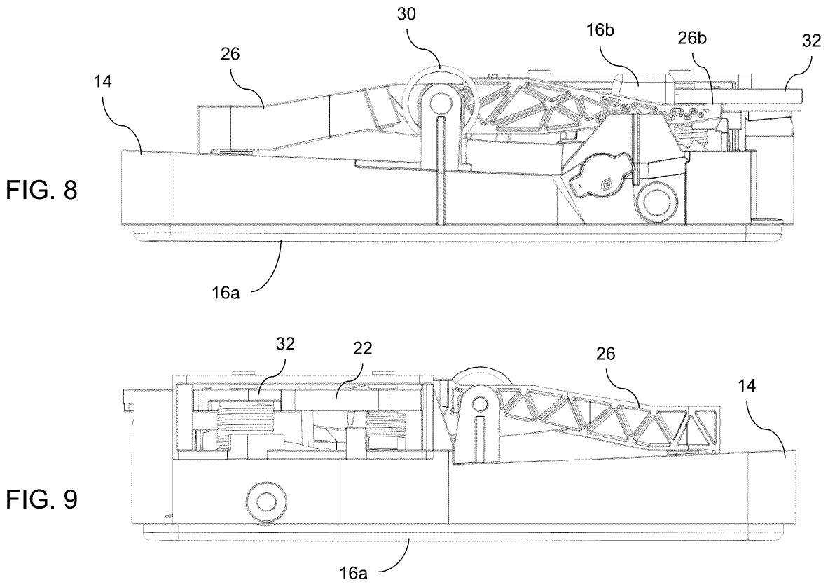

The deployment mechanism 20 includes a deployment latch 26 attached to the base portion 14, such as pivotally attached relative to the base portion 14 via a pivot pin 28 defining a pivot axis of the deployment latch 26. The deployment latch 26 includes a standoff or handle engaging portion 26a at a first end of the deployment latch 26 and a catch or latch element 26b at a second end of the deployment latch 26 opposite the first end, with the pivot pin 28 extending through the deployment latch 26 at a position between the standoff 26a and the latch element 26b. The standoff 26a extends through the base portion 14 to engage a rear surface of the handle portion 16 within the recess of the base portion 14 (FIG. 6). Thus, when the handle portion 16 is pushed inward from the recessed position (i.e., the user input is applied to deploy the handle), pivoting of the handle portion 16 toward the base portion pivots the deployment latch 26 in a first direction about the pivot pin 28 (e.g., clockwise in FIG. 8). The deployment latch 26 may be biased relative to the base portion about the pivot axis in a second direction that is opposite the first direction (e.g., counter clockwise in FIG. 8) by a biasing element 30, such as a torsion spring disposed about the pivot pin 28 and engaging the deployment latch 26 and the base portion 14. Thus, the deployment latch 26 is biased against the direction of the user input to bias the handle portion 16 outward from the recess of the base portion 14, and such as to be flush with the door panel.

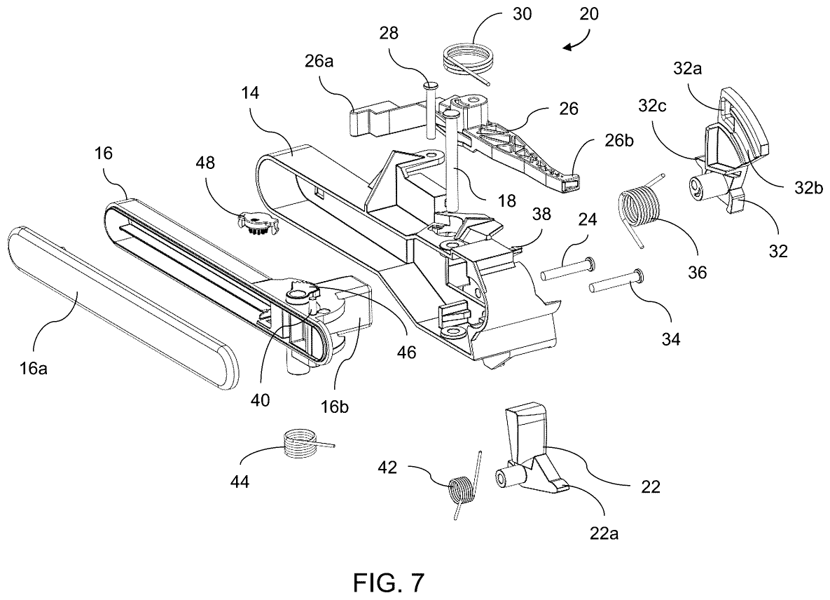

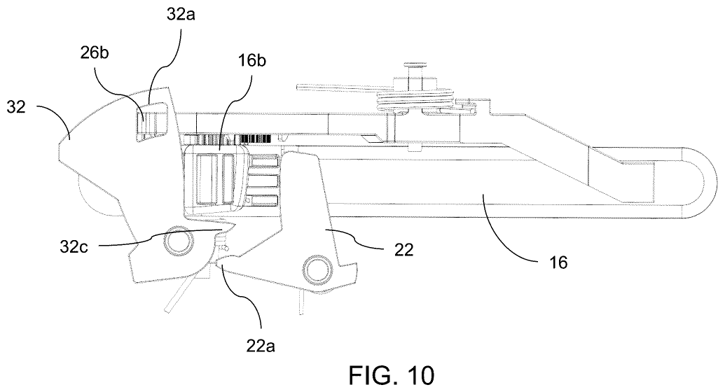

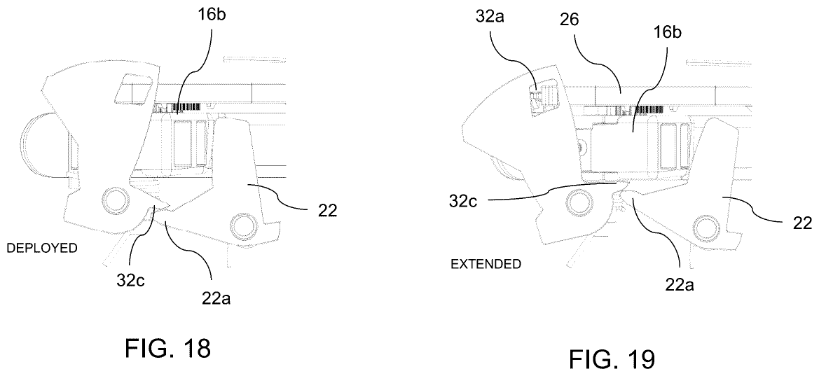

At the second end of the deployment latch 26, the latch element 26b is configured to engage a handle return cam 32. For example, when the handle is in the recessed or non-use position (such as shown in FIGS. 4, 6, and 11), the latch element 26b engages a tab or recess 32a of the handle return cam 32. The handle return cam 32 is pivotally attached relative to the base portion 14, such as via a pivot pin 34 (FIG. 7), and is positioned adjacent the lever 16b of the handle portion 16 (FIG. 10) so that, when the handle return cam 32 pivots relative to the base portion 14, the handle return cam 32 may engage the lever 16b and impart pivotal movement of the handle portion 16 toward the deployed position. As shown in FIG. 18, when the handle 16 in the deployed position, the lever 16b engages the cable pull cam 22 so that when the handle portion 16 is further pivoted by the user toward the extended position, the lever 16b imparts pivotal movement of the cable pull cam 22 (FIG. 19). The handle return cam 32 is biased toward the lever 16b by a biasing element 36 (FIG. 7), such as a torsion spring disposed about the pivot pin 34.

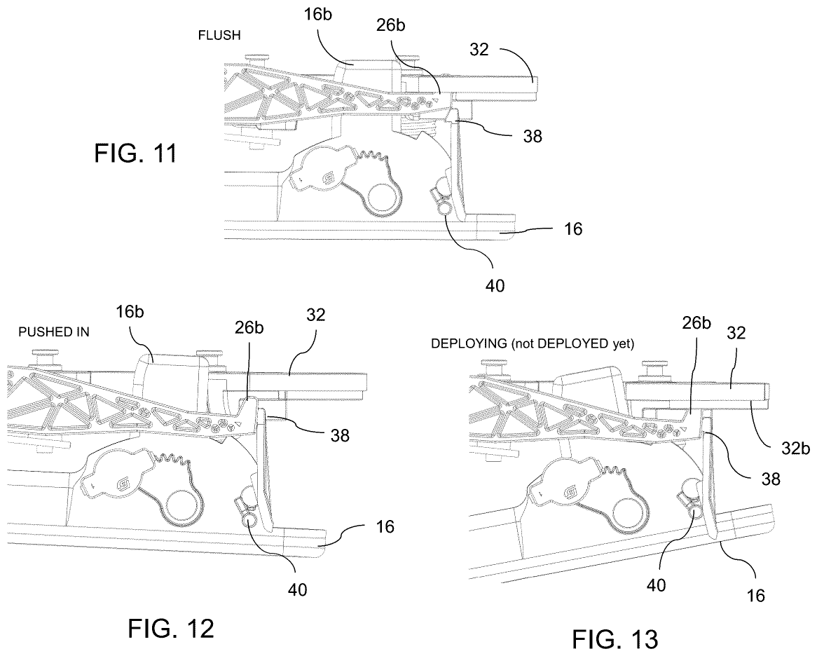

As shown in FIG. 11, when the handle portion 16 is in the recessed position, the latch element 26b is engaged with the handle return cam 32 to maintain the position of the handle return cam 32 relative to the lever 16b (i.e., to prevent the handle return cam 32 from pivoting due to the biasing of the torsion spring 36). As shown in FIG. 12, when the deployment latch 26 is pivoted in the first direction by the user input (i.e., by a user pushing the handle portion inward toward the door), the deployment latch 26 pivots and the latch element 26b moves out of engagement with the handle return cam 32. With the latch element 26b moved out of engagement with the handle return cam 32, the handle return cam 32 is free to pivot relative to the base portion 14 toward the lever 16b according to the force provided by the biasing element 36 to extend the handle from the recessed position toward the deployed position.

A tab or latch catch 38 coupled to the base portion 14 is configured to engage the deployment latch 26 at the second end at or near the latch element 26b when the latch element 26b moves out of engagement with the handle return cam 32 to hold the deployment latch 26 and prevent the latch element 26 from reengaging the tab 32a of the handle return cam 32 as the handle return cam 32 pivots to deploy the handle. That is, as the deployment latch 26 pivots in the first direction out of engagement with the handle return cam 32, the latch catch 38 engages the deployment latch 26 and prevents the deployment latch 26 from pivoting back in the second direction into engagement with the handle return cam 32. The latch catch 38 may be integrally formed with the base portion 14 and flex relative to the base portion 14 to accommodate the movement of the deployment latch 26 into engagement with the latch catch 38. The latch catch 38 may include a hook or engaging element at a distal end that is received into a recess or tab at the second end of the deployment latch 26.

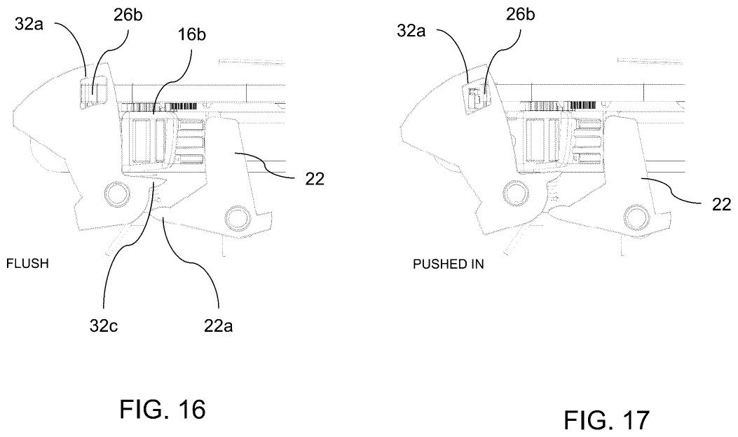

Thus, when the handle portion 16 is in the recessed position and is moved further toward the base portion 14 (i.e., the handle is pushed or depressed inward), the deployment latch 26 is pivoted out of engagement with the handle return cam 32. The latch catch 38 engages the deployment latch 26 when it is moved out of engagement with the handle return cam 32 to prevent the deployment latch 26 from reengaging the handle return cam 32 until the latch catch 38 releases the deployment latch 26. The handle return cam 32 is biased toward engagement with the lever 16b of the handle portion 16 and pivots relative to the base portion 14 to act on the lever 16b and impart pivotal movement of the handle portion 16 toward the deployed position (e.g., see FIGS. 16-18 where the latch catch 38 is disengaged from the tab 32a of the handle return cam 32 and the handle return cam 32 pivots to deploy the handle via engagement with the lever 16b). With the handle portion 16 in the deployed position, the lever 16b is positioned to engage and act on the cable pull cam 22 so that, when the handle is pulled by a user and pivoted beyond the deployed position to the extended position, movement of the lever 16b pivots the cable pull cam 22 relative to the base portion 14 to open the door (e.g., FIG. 19).

As shown in FIGS. 11-15, the handle portion 16 includes a ramp or pin 40 that engages the latch catch 38 and travels along the latch catch 38 as the handle portion 16 pivots between the recessed, deployed and extended positions. The pin 40 and the latch catch 38 have a ramped engagement interface (i.e., the latch catch 38 may include the ramped or tapered portion) so that, with the latch catch 38 engaging the deployment latch 26 to prevent the deployment latch 26 from reengaging the handle return cam 32 and as the handle portion 16 pivots toward the deployed position, the pin 40 travels along the latch catch 38 to move the latch catch 38 out of engagement with the deployment latch 26 once the handle return cam 32 has pivoted such that the recess 32a is not aligned with the latch element 26b. That is, as the handle portion 16 is moved toward the deployed position, the pin 40 at the handle portion 16 travels along the ramped interface of the latch catch 38 to move the latch catch 38 out of engagement with the deployment latch 26. Thus, after the latch catch 38 releases the deployment latch 26, the deployment latch 26 pivots toward the handle return cam 32 and the latch element 26b may reengage the handle return cam 32 and travel along a channel or outer surface 32b of the handle return cam 32 as the handle return cam 32 pivots in a first pivoting direction (e.g., clockwise in FIG. 10) to further extend the handle portion 16 toward the deployed position.

As shown in FIGS. 16-19, when the handle return cam 32 pivots in the first pivoting direction (e.g., clockwise in FIGS. 16-19), the lever 16b is moved in the second direction (e.g., counter clockwise in FIG. 8) relative to the handle return cam 32 to pivot the handle portion 16 toward the deployed position. With the handle portion 16 in the deployed position, the lever 16b is positioned to act on the cable pull cam 22 and a gear or tooth 32c of the handle return cam 32 is positioned adjacent to a gear or tooth 22a of the cable pull cam 22 (FIG. 18). When the handle is pivoted beyond the deployed position toward the extended position to open the door, the lever 16b moves further in the second direction and pivots the cable pull cam 22 in the first pivoting direction (FIG. 19). When the cable pull cam 22 pivots in the first pivoting direction, the teeth 22a, 32c of the cable pull cam 22 and the handle return cam 32 engage one another and the handle return cam 32 pivots in a second pivoting direction (e.g., counter clockwise in FIGS. 16-19) opposite the first pivoting direction.

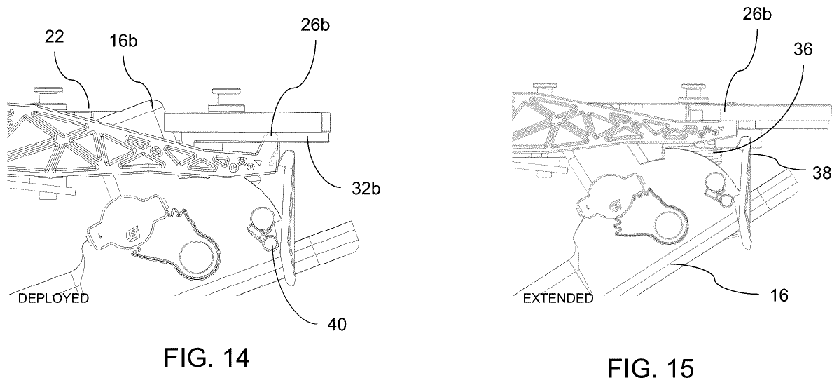

Referring to FIGS. 14, 15, 18, and 19, as the cable pull cam 22 pivots in the first pivoting direction and the handle return cam 32 pivots in the second pivoting direction, the latch element 26b of the deployment latch 26 (which is released from the latch catch 38) travels along the channel 32b of the handle return cam 32 and is biased into engagement with the handle return cam 32 by the biasing element 30 (FIG. 8). Thus, as the handle return cam 32 pivots in the second pivoting direction and when the latch element 26b aligns with the recess or tab 32a of the handle return cam 32, the latch element 26b is biased into the recess 32a and engages the handle return cam 32 to prevent the handle return cam 32 from pivoting back in the first pivoting direction. In other words, when the handle portion 16 is moved to the extended position and thus pivots the cable pull cam 22 relative to the handle return cam 32, the handle return cam 32 is pivoted toward the latch element 26b and is engaged by the latch element 26b to reset the handle return cam 32.

After the handle is pivoted beyond the deployed position to the extended position and released by the user, and with the latch element 26b engaging the recess 32a of the handle return cam 32, the cable pull cam 22 is biased in the second pivoting direction by a biasing element 42 (such as a torsion spring disposed about the pivot pin 24) (FIG. 7) and pivots in the second pivoting direction. An additional biasing element 44 (such as a torsion spring disposed about the pivot pin 18) may bias the handle portion 16 from the deployed position toward the recessed position. Thus, due to the cable pull cam 22 pivoting in the second pivoting direction and acting upon the lever 16b and/or the handle portion 16 being biased by the biasing element 44, the handle portion 16 pivots from beyond the deployed position to the recessed position after being released by the user. In some implementations, the cable pull cam 22 pivoting in the second pivoting direction and acting upon the lever 16b may pivot the handle portion 16 from the extended position to the deployed position and the biasing force of the biasing element 42 may pivot the handle portion 16 from the deployed position toward the recessed position.

When the handle portion 16 is pivoted from the recessed position to the deployed position by the deployment mechanism 20, the handle portion 16 may be manually returned to the recessed position (without first pivoting the handle beyond the deployed position) by the user providing a force to push the handle from the extended position to the recessed position. In such case, because the ramped interface between the pin 40 and the latch catch 38 releases the latch catch 38 from the deployment latch 26 as the handle is deployed (e.g., FIG. 14), pushing the handle portion 16 from the deployed position to the recessed position causes the lever 16b to act upon the handle return cam 32 and pivot the handle return cam 32 in the second pivoting direction. As the handle return cam 32 pivots in the second pivoting direction, the latch element 26b travels along the channel 32b and is biased into the recess 32a to engage the handle return cam 32 at the recess 32a and retain the handle return cam 32 with the handle returned to the recessed position. Thus, the handle is secured in the recessed position and reset so that, if the user subsequently depresses the handle, the deployment mechanism 20 again deploys the handle.

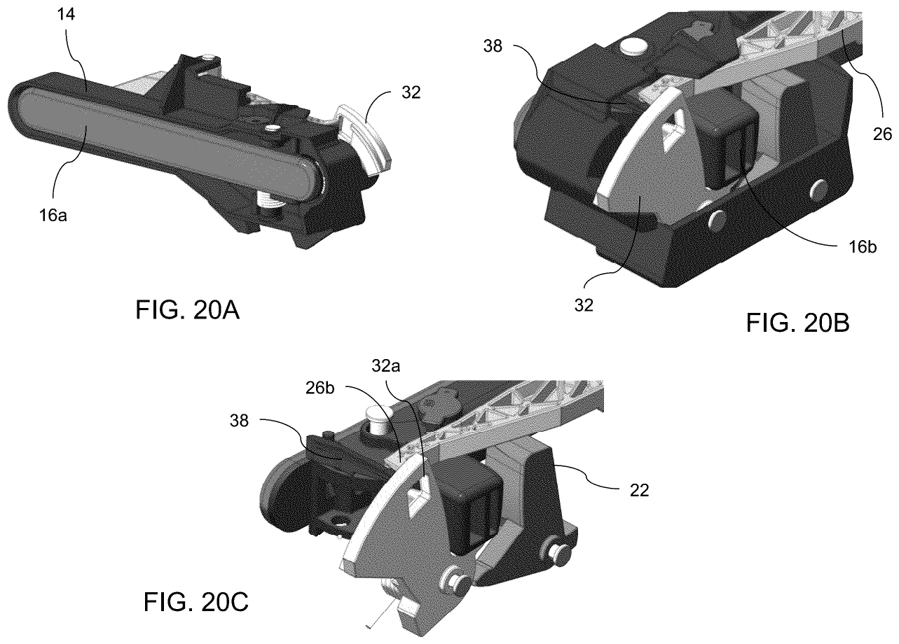

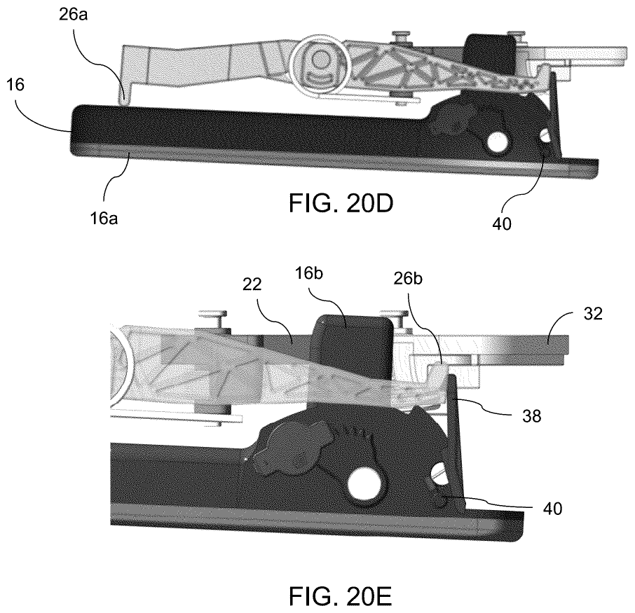

Referring now to FIGS. 20A-24E, operation of the door handle assembly and pivoting of the handle portion 16 relative to the base portion 14 from the recessed position to the deployed or graspable position and automatic pivoting of the handle portion from the extended position back toward the recessed position after the handle portion is pivoted beyond the deployed position to the extended position to open the door is described further below.

As shown in FIGS. 20A-20E, the handle portion 16 is in a depressed or actuated position, where the handle portion 16 has been manually pressed in toward the base portion 14 to actuate the deployment mechanism 20. That is, from a flush state (FIGS. 8-10), the handle portion 16 is manually pressed on the class A surface 16a (i.e., the outer most surface of the handle that is exposed at the door of the vehicle) inward (e.g., normal to the sheet metal surface of the door panel) until the deployment latch 26 is released from the handle return cam 32. The deployment latch 26 is pushed in with the handle 16 due to engagement between the standoff 26a and the handle portion 16 at the end of the handle 16 opposite the pivot pin 18. This end of the deployment latch 26 is used to constrain the flush position of the handle 16 relative to the depth or recess of the base portion 14 from the sheet metal of the door panel. The deployment latch 26 pivots in the first direction until it becomes free of the handle return cam 32 and connects to the latch catch 38 located on the bracket 14. That is, pressing on the handle portion 16 by the user causes the deployment latch 26 to pivot relative to the base portion 14 and the handle return cam 32, disengaging the latch element 26b from the handle return cam 32 and engaging the deployment latch 26 with the latch catch 38. For example, in the flush state (FIG. 11), the latch element 26b is engaged with the handle return cam 32, and when the handle is pushed in, the latch element 26b moves out of engagement with the handle return cam 32 and is caught or engaged by the latch catch 38 to keep the latch element 26b out of engagement with the handle return cam 32 (FIGS. 12, 20D, and 20E). As shown in FIGS. 16 and 17, when the handle 16 is pressed into the base portion 14, the lever 16b acts on the handle return cam 32 and pivots the handle return cam 32 at least slightly in the second pivoting direction to provide clearance for releasing the latch element 26b from the tab 32a of the handle return cam 32.

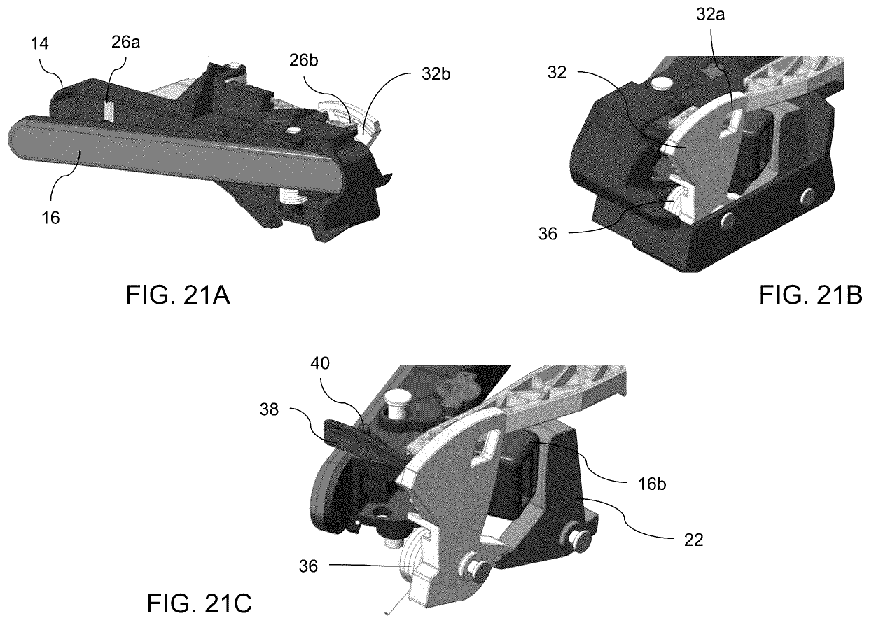

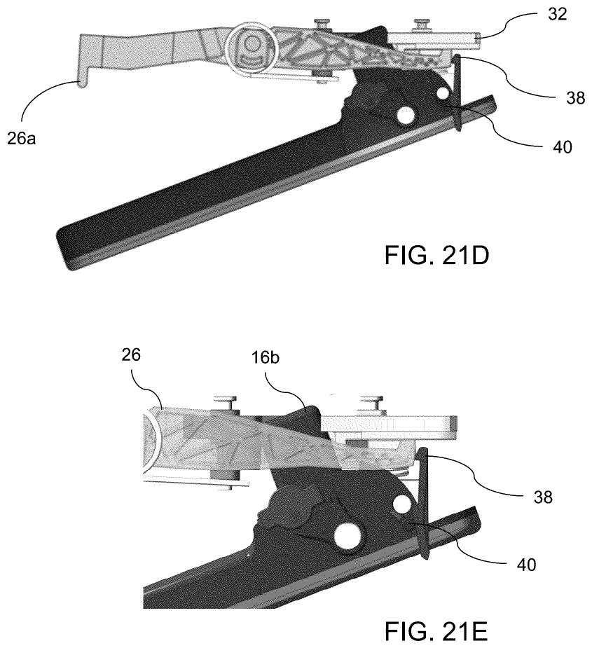

Engaging the deployment latch 26 with the latch catch 38 allows the handle return cam 32 to rotate or pivot over the deployment latch 26 in the first pivoting direction and push the handle portion 16 out to the deployed position for the user to grab. For example, and as shown in FIG. 21A, the latch element 26b engages the handle return cam 32 and travels along the channel 32b of the handle return cam 32 as the handle return cam 32 pivots in the first pivoting direction.

As shown in FIGS. 21A-21E, after manual input by the user, the deployment mechanism 20 operates to pivot the handle 16 out from the base portion 14 to the deployed position to be grasped by the user. The handle return cam 32 is biased by the torsion spring 36 and, after the handle 16 is pressed and released and the deployment latch 26 is not engaging the tab 32a of the handle return cam 32, the handle return cam 32 pivots in the first pivoting direction until a travel stop on the handle return cam 32 contacts or engages the base portion 14. At this point, the handle 16 is in the deployed position and the lever 16b is in position to act on the cable pull cam 22 (e.g., the lever 16b is disposed adjacent to and/or engaging the cable pull cam 22). When the handle 16 reaches deployment, the post or pin 40 of the handle 16 has pushed the catch 38 located on the base portion to release the deployment latch 26. That is, going from the pushed-in state to the deployed state, the post 40 on the handle portion 16 rides up a ramp on the bracket catch 38 so that the deployment latch 26 is released at the correct time in deployment. Without the bracket catch 38, the deployment latch 26 may not release from the handle return cam 32 when the handle 16 is pushed in. Once deployed, the handle 16 can be pulled by the user.

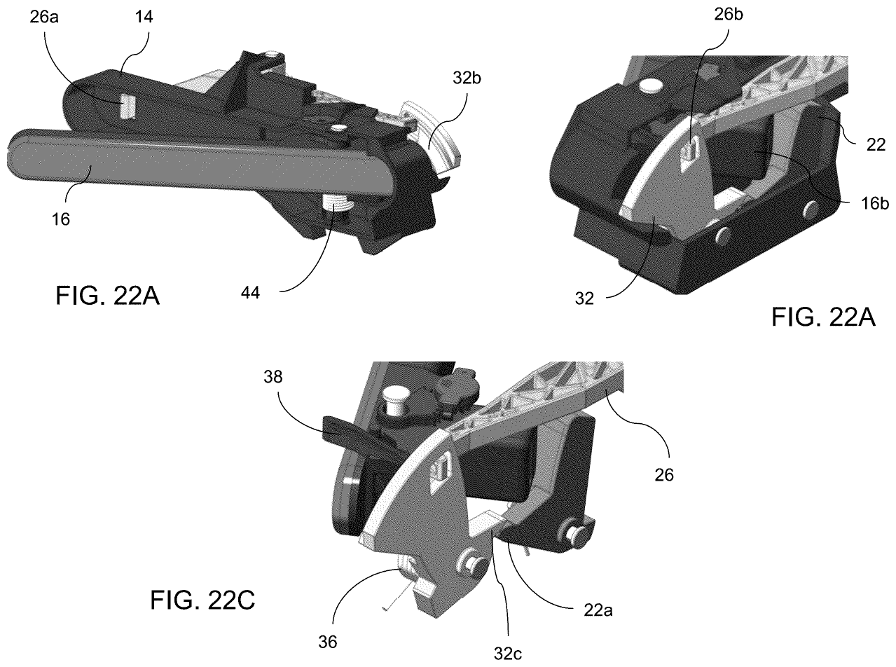

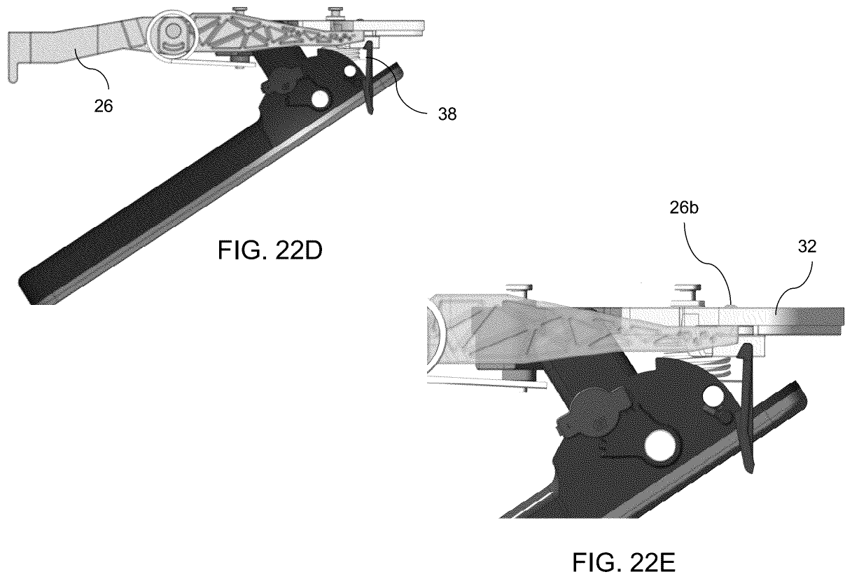

As shown in FIGS. 22A-22E, the handle has been manually pivoted beyond the deployed position to the extended position by the user to open the door. Upon the user pulling the handle 16, the cable pull cam 22 is acted on by the lever 16b, and pivots in the first pivoting direction. While the cable pull cam 22 pivots in the first pivoting direction (e.g., clockwise in FIG. 22C), the cable pull cam 22 acts on the handle return cam 32 through a gear tooth interface, so that the handle return cam 32 is wound in the second pivoting direction (e.g., counterclockwise in FIG. 22C) until the deployment latch 26 locks the handle return cam 32 in place. That is, as the handle 16 is pivoted beyond the deployed position and the lever 16b pivots the cable pull cam 22 in the first pivoting direction, the tooth or gear 22a of the cable pull cam 22 engages the tooth or gear 32c of the handle pull cam 32 to pivot the handle pull cam 32 in the second, opposite pivoting direction toward engagement with the deployment latch 26. During this movement, the cable pull cam 22 pulls the door latch to release the door latch and allow the user to open the door. The handle 16 may then return to flush by the biasing force of the torsion spring 44.

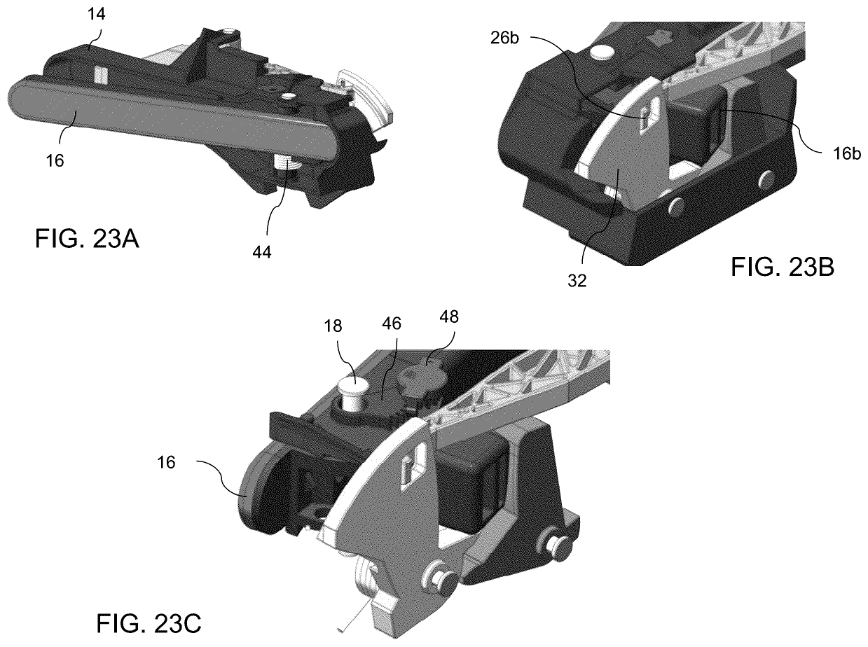

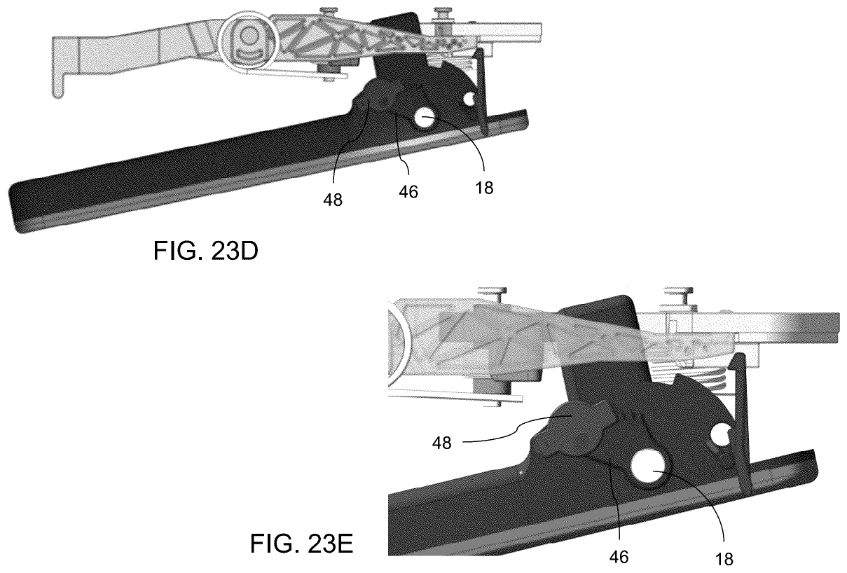

As shown in FIGS. 23A-23E, after the handle has been manually pivoted beyond the deployed position to the extended position and released by the user, the deployment mechanism 20 pivots the handle portion 16 from the extended position toward the recessed position. As shown, the deployment latch 26 is engaged with the handle return cam 32 so that the biasing member 44 may return the handle portion 16 toward the recessed position without the handle return cam 32 engaging the lever 16b. The handle portion 16 may include a rotary damper that allows the handle to return to the flush state at a smooth and controlled rate. For example, the rotary damper may include an arcuate gear element 46 disposed about the pivot pin 18 that pivots with the handle portion 16 about the pivot pin 18, where the arcuate gear element 46 engages a stationary gear element 48 that does not pivot with the handle portion 16. As the handle portion 16 pivots, the arcuate gear element 46 engages the stationary gear element 48 and pivoting of the handle and arcuate gear element 46 rotates the stationary gear element 48. The stationary gear element 48 provides resistance to pivoting of the handle via engagement with the arcuate gear element 46 to slow or reduce the rate of pivoting.

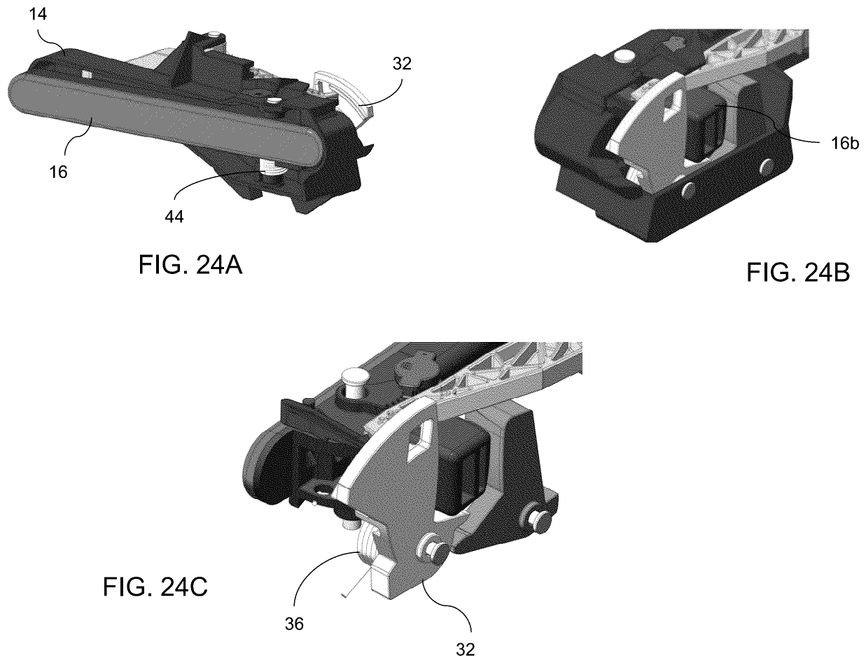

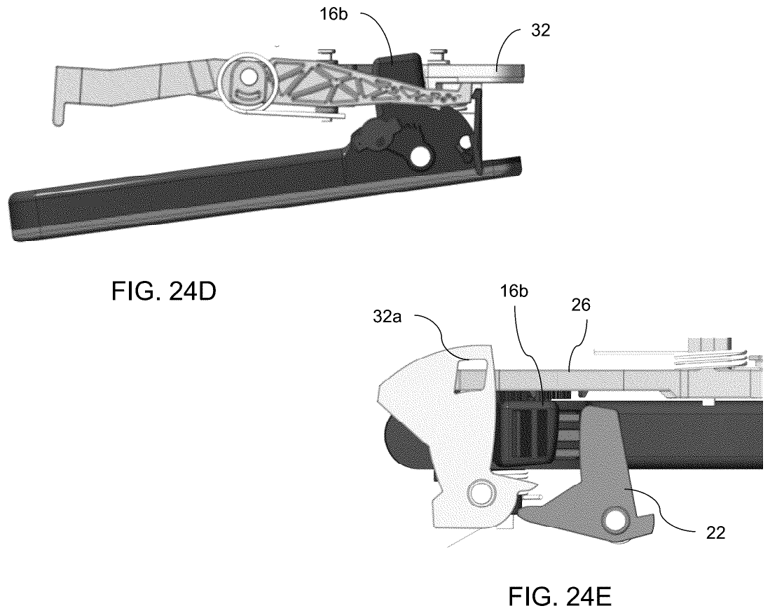

After the handle has been deployed, if the handle is not pivoted beyond the deployed position to the extended position to open the door, the handle may be manually returned to the recessed position. As shown in FIGS. 24A-24E, the handle portion 16 is between the deployed position and the recessed position while the handle portion 16 is being manually returned to the recessed position. That is, once deployed, the handle 16 can be pushed flush by the user without requiring that the handle 16 be pulled first. The user can push the handle 16 inward toward the vehicle. The handle return cam 32 rotates in the second pivoting direction (e.g., counterclockwise in FIG. 24C) as the lever 16b of the handle portion 16 pushes on it. This motion winds the torsion spring 36 on the handle return cam 32. Once the handle return cam 32 reaches the preloaded position, the deployment latch 26 locks the handle return cam 32 in place and the system returns to the flush or recessed state.

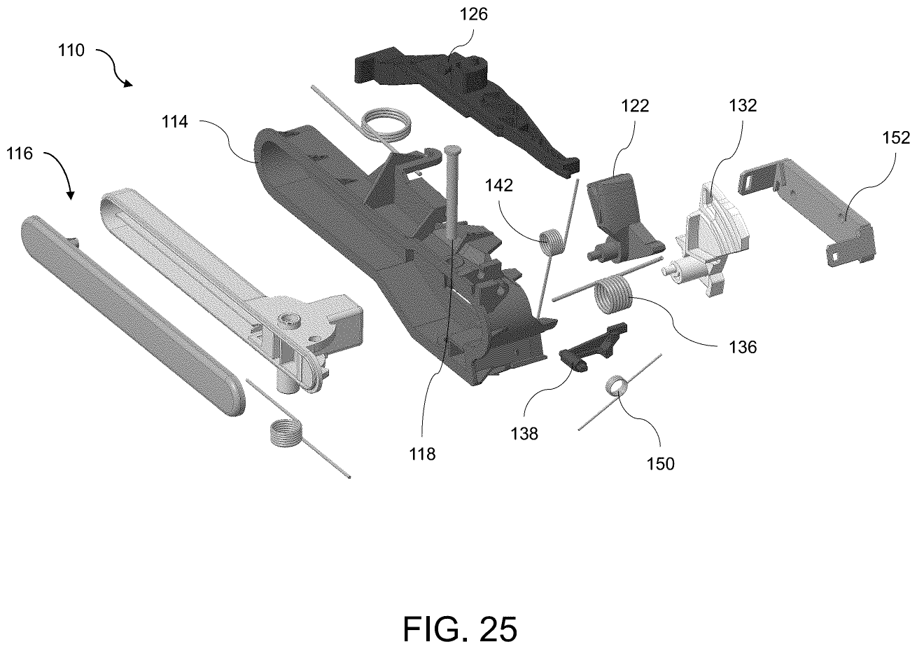

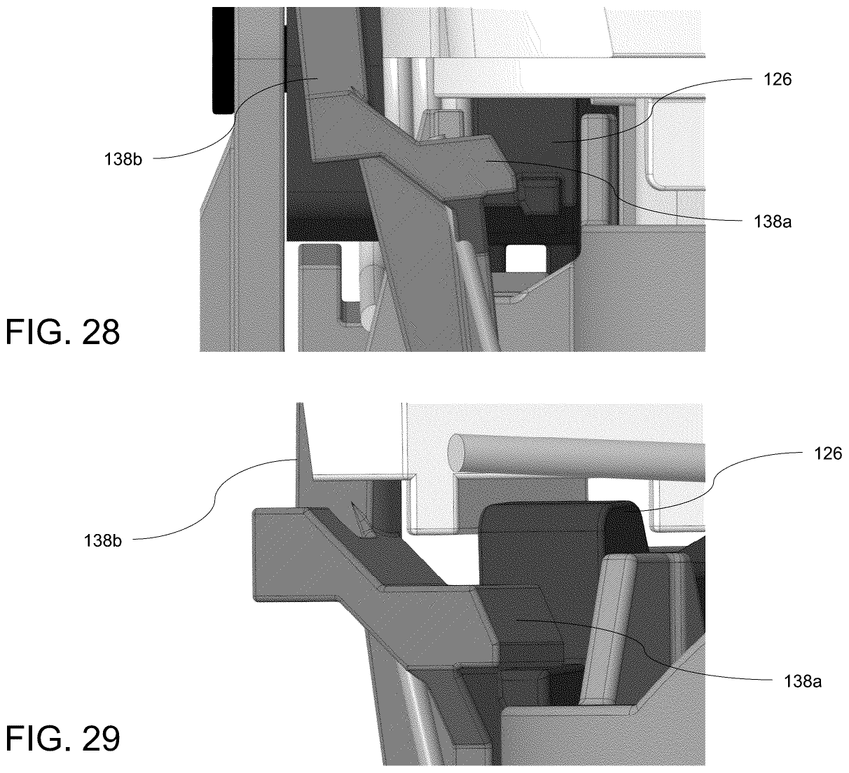

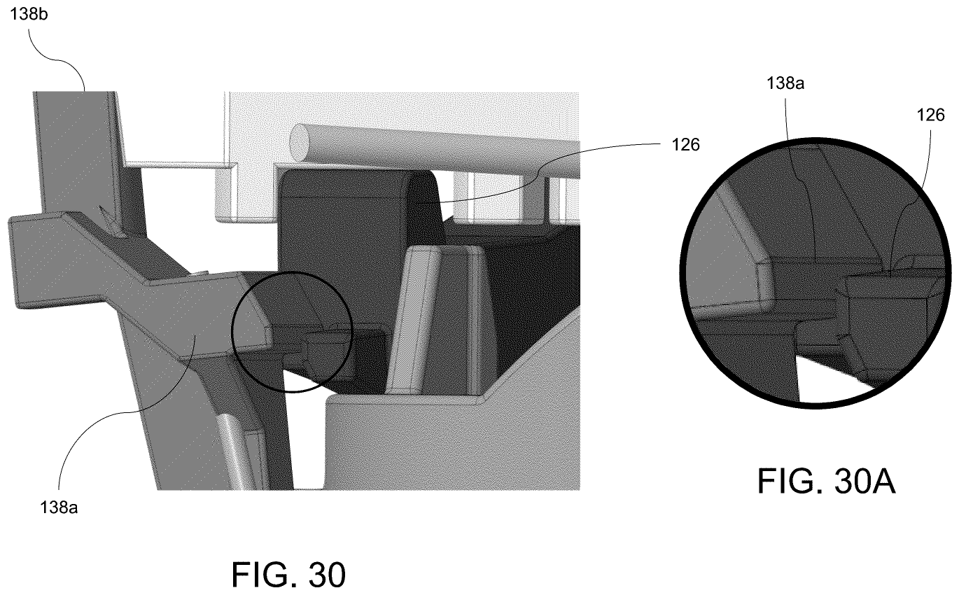

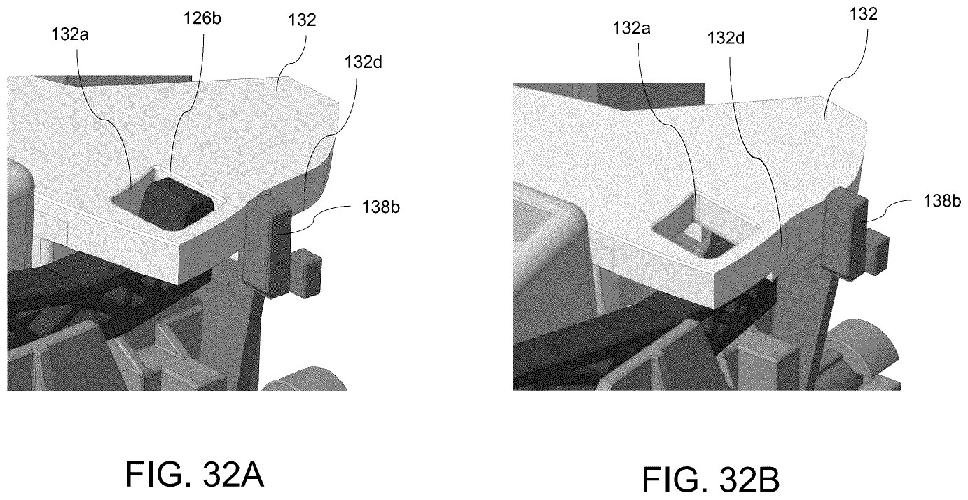

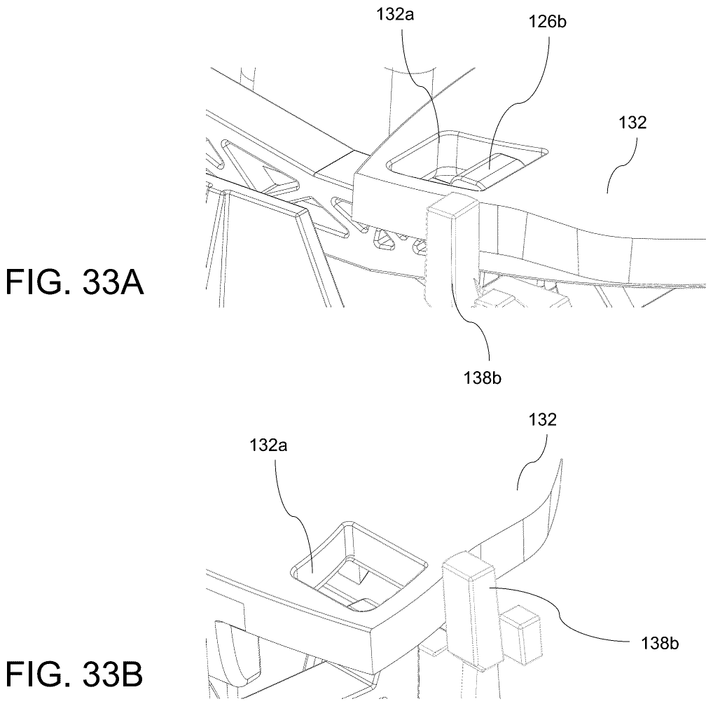

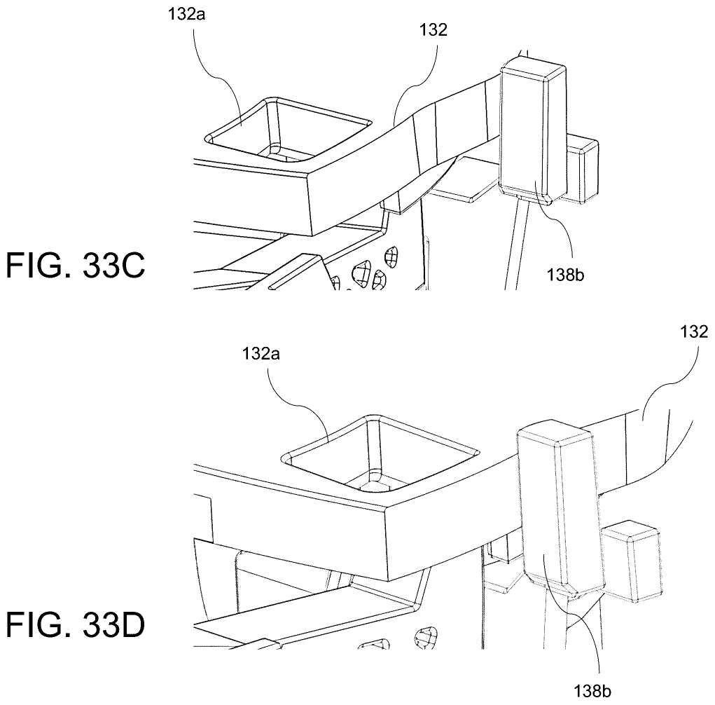

Referring to FIGS. 25-33D, a handle assembly 110 may include a tab or latch catch or latch release mechanism 138 that includes a tab or catch portion 138a configured to engage the deployment latch 126 and a guide portion 138b that rides or moves along a contoured or ramped or detent surface 132d of the handle return cam or handle deployment cam 132 as the handle return cam 132 pivots relative to the base portion 114. The latch release mechanism 138 is pivotally attached at the base portion 114 and biased toward engagement with the handle return cam 132 and the deployment latch 126, such as via a biasing element 150 (e.g., a torsion spring).

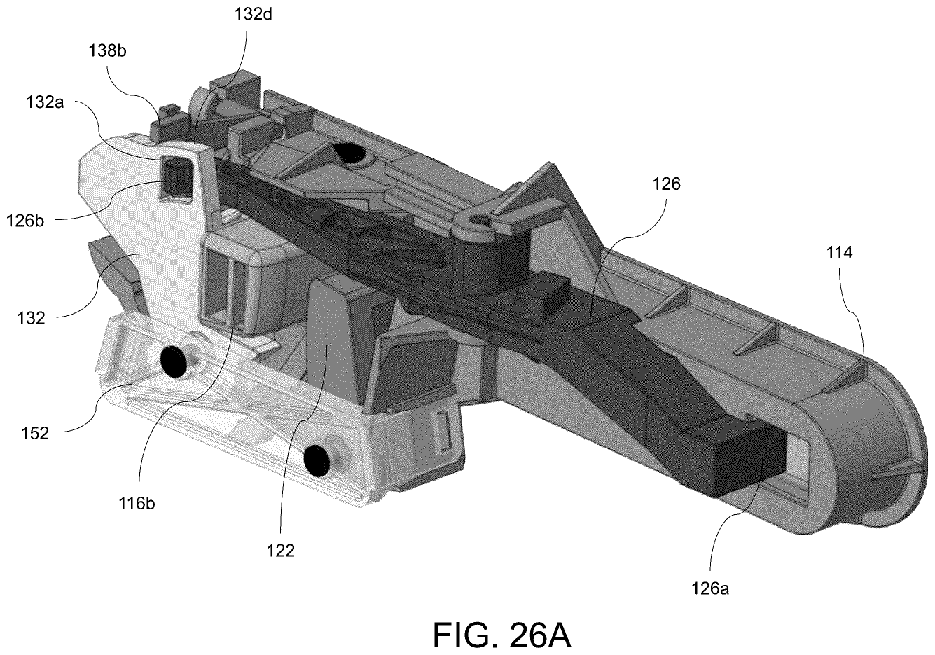

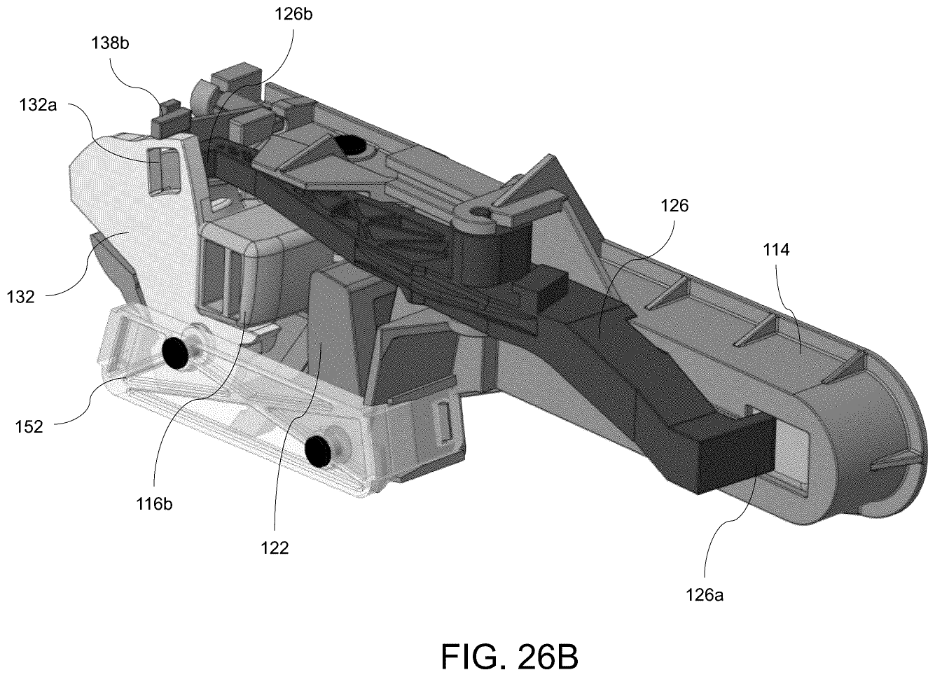

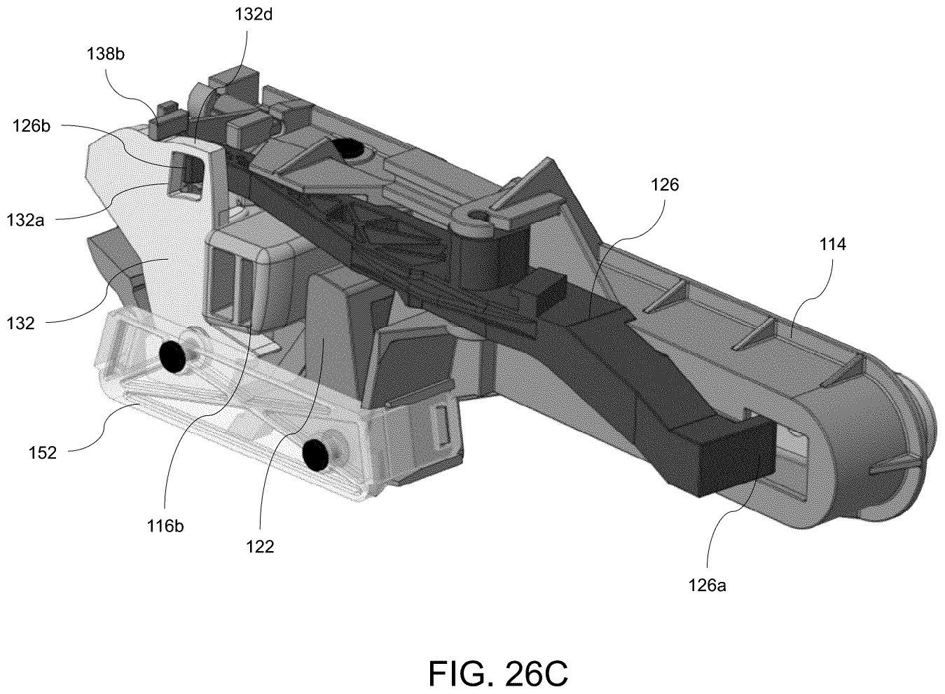

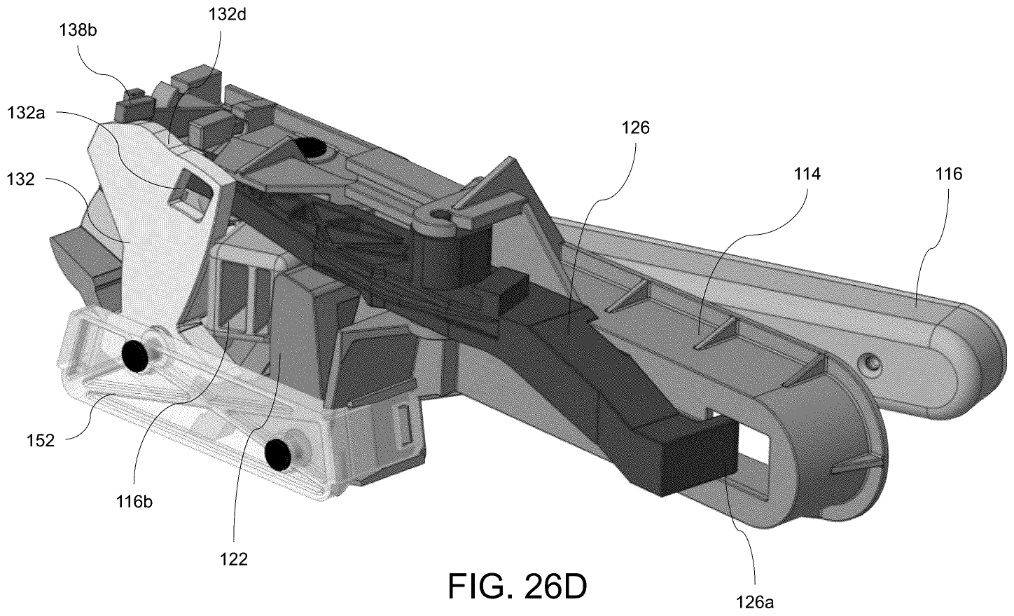

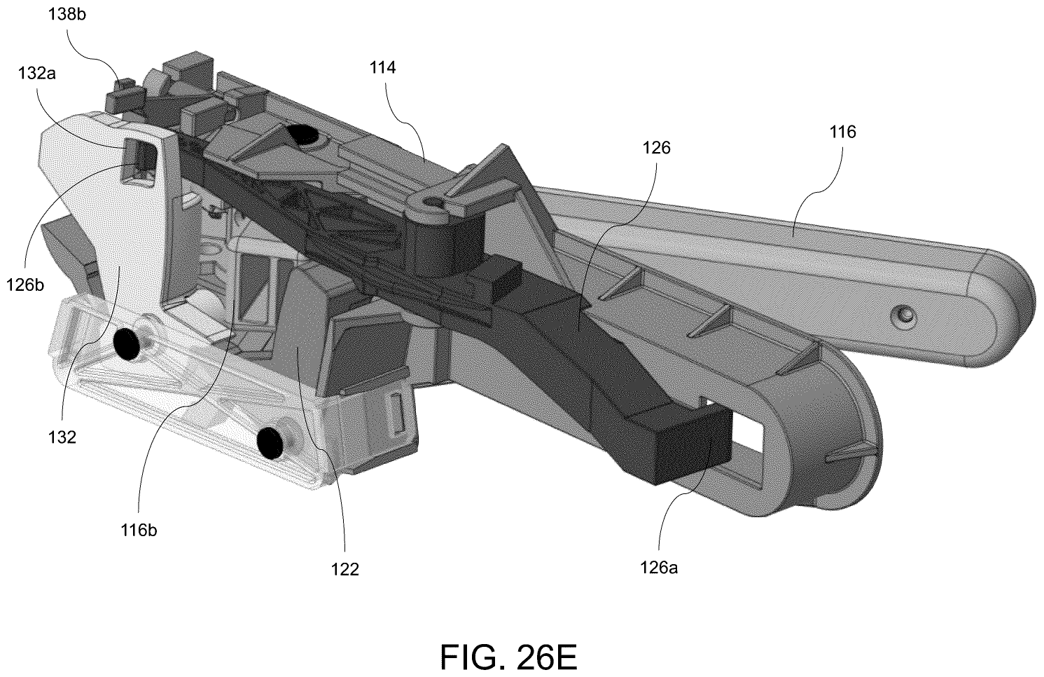

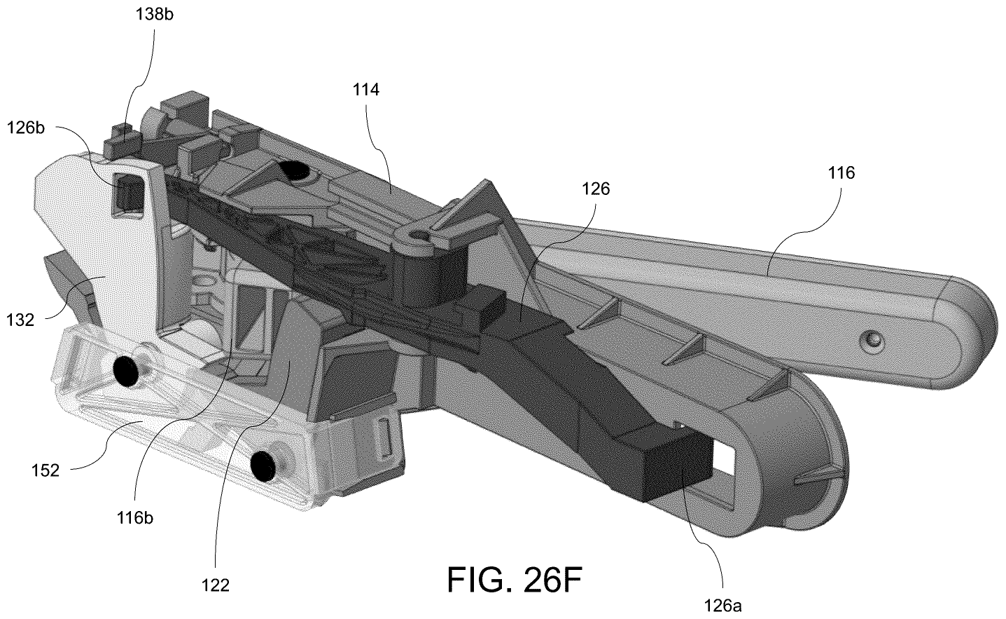

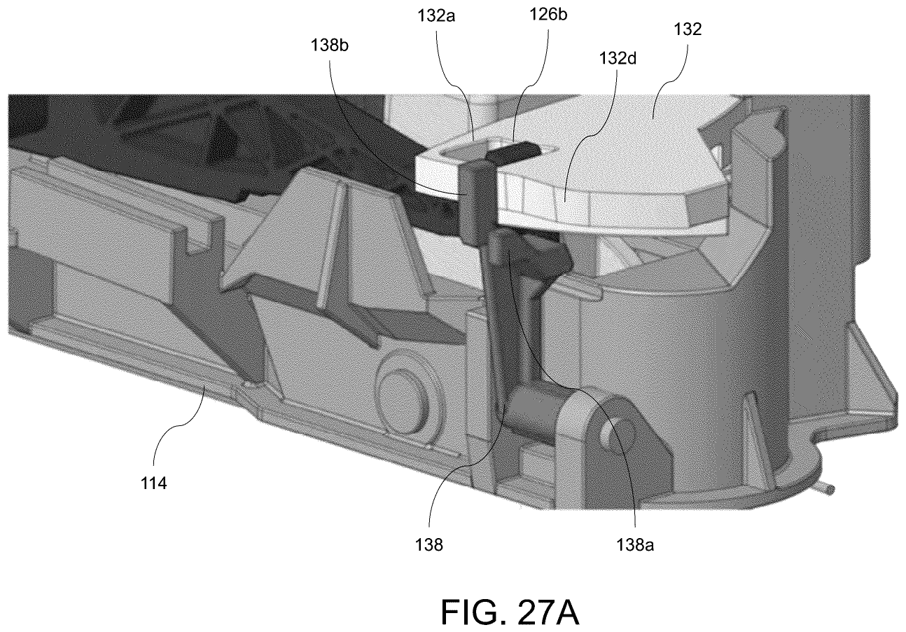

Thus, with the handle 116 in the flush or retracted or undeployed position (FIGS. 26A, 27A, 31A, 32A, and 33A), the latch element 126b of the deployment latch 126 is received in or engages the window or tab 132a of the handle return cam 132 and the standoff 126a of the deployment latch 126 engages the rear surface or portion of the handle 116. The guide portion 138b of the latch release mechanism 138 is at a position along the contoured surface 132d of the handle return cam 132 such that the catch portion 138a is moved out of engagement with the deployment latch 126.

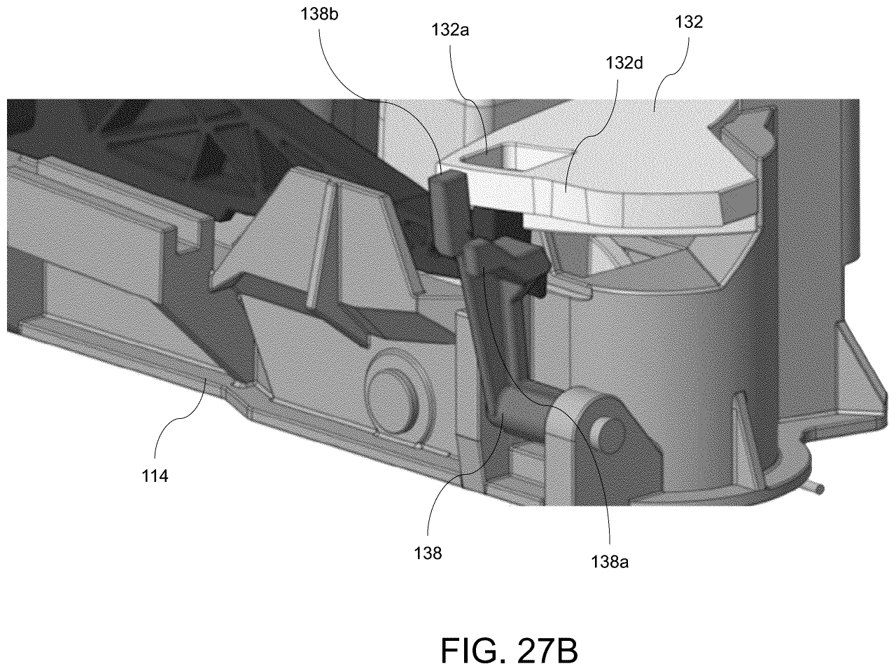

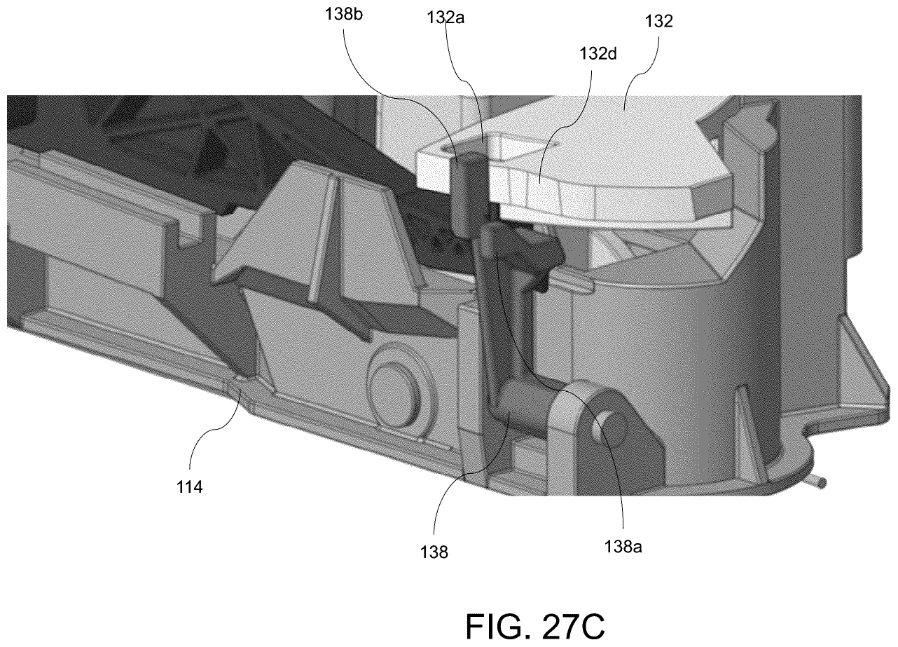

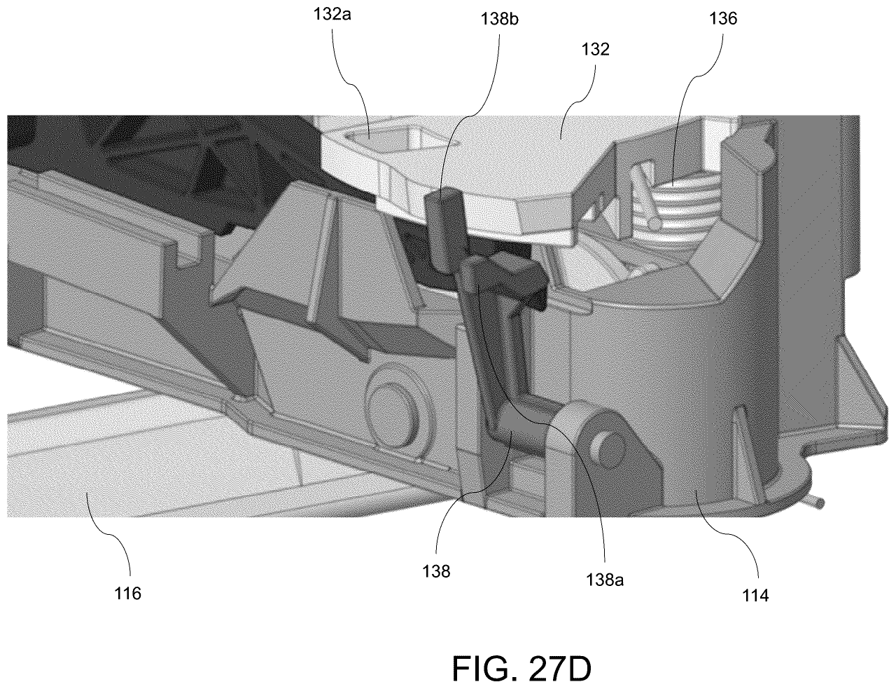

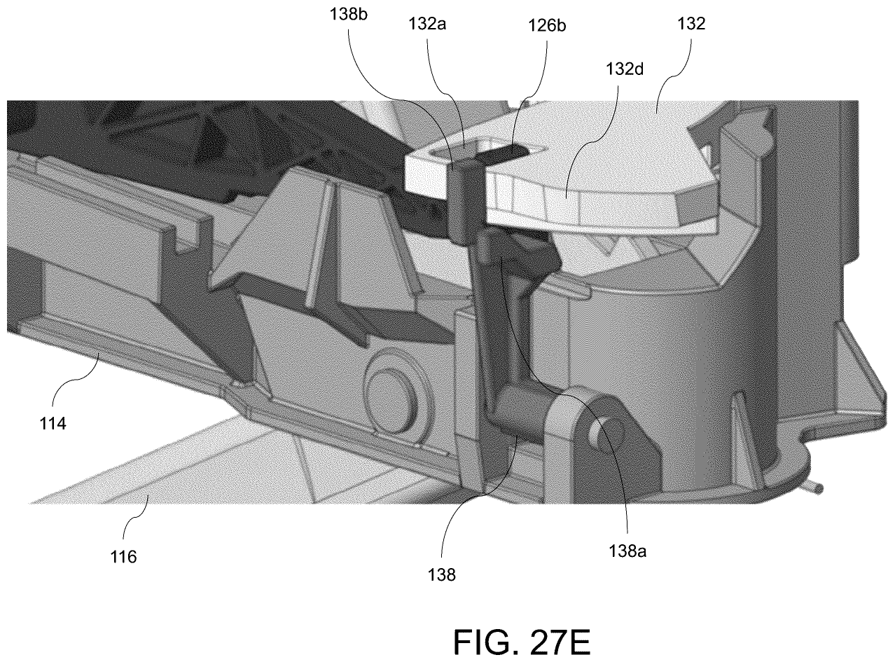

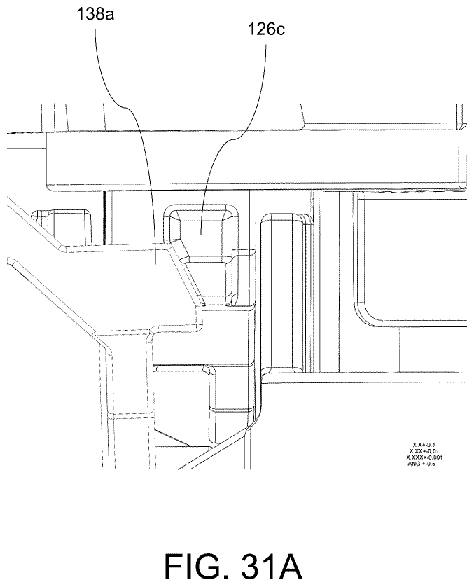

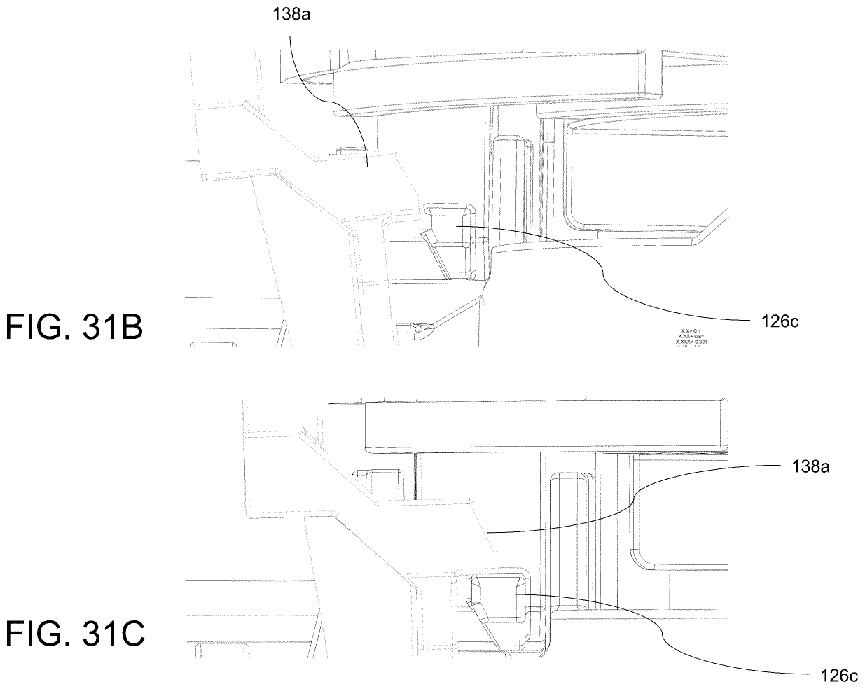

As the handle 116 is depressed or moved toward the base portion 114 by the user, the lever 116b of the handle 116 pivots the handle return cam 132 (e.g., counterclockwise in FIG. 26B) and moves the latch element 126b out of engagement with the tab 132a of the handle return cam 132. Pivoting of the handle return cam 132 causes the guide portion 138b of the latch release mechanism 138 to move along the surface 132d of the handle return cam 132a and against the biasing force of the biasing element 150 away from the handle return cam 132a and the deployment latch 126. This allows the deployment latch 126 to move or pivot past the catch portion 138a of the latch release mechanism 138. Further, the deployment latch 126 may include a ramped surface 126c (FIGS. 31A-31C) that engages the latch release mechanism 138 to pivot or move the latch release mechanism 138 away from the deployment latch 126 as the deployment latch 126 is pivoted out of engagement with the handle return cam 132 and into engagement with the latch release mechanism 138. With the handle 116 depressed toward the base portion 114 and the deployment latch 126 moved out of engagement with the handle return cam 132, the catch portion 138a of the latch release mechanism 138 engages the deployment latch 126 to preclude the deployment latch 126 from re-engaging the handle return cam 132 (FIG. 27C).

The handle return cam 132 is thus free to pivot toward the lever 116b of the handle 116 to move the handle 116 toward the deployed position, and the guide portion 138b moves along the surface 132d of the handle return cam 132 and thus moves the catch portion 138a away from engagement with the deployment latch 126 as the handle return cam 132 pivots toward the lever 116b. Thus, the deployment latch 126 may disengage from the latch release mechanism 138 and engage and move or ride along the contoured surface 132d of the handle return cam 132 as the handle return cam 132 pivots toward the deployed position (FIGS. 26D, 27D and 28-30A).

When the handle 116 is moved further beyond the deployed position (FIGS. 26F and 27E), the geared or toothed relationship between the cable pull cam 122 and the handle return cam 132 pivots the handle return cam 132 back toward engagement with the deployment latch 126. Thus, with the deployment latch 126 disengaged from the latch release mechanism 138, the deployment latch 126 rides along the surface 132d of the handle return cam 132 and back into engagement with the tab or window 132a of the handle return cam 132 to secure the handle return cam 132 and deployment latch 126 as the handle 116 is returned to the flush position. The latch release mechanism 138 is biased toward the contoured surface 132d of the handle return cam 132 and, as the deployment latch 126 re-engages the window 132a of the handle return cam 132, the latch release mechanism 138 moves into engagement with the surface 132d of the handle return cam 132.

Thus, the latch catch or latch release mechanism 138 allows the deployment latch 126 to lift, or move away from the handle return cam 132, after release, to prevent the deployment latch 126 from re-engaging with the window or tab 132a in the handle deploy cam or handle return cam 132 as the handle return cam 132 rotates past or over the deployment latch 126.

That is, the latch release mechanism 138 constrains the deployment latch 126 so that the handle deployment cam 132 may rotate past or over the deployment latch 126 and allow the handle 116 to deploy. Once the window or tab 132a in the handle deployment cam 132 passes or moves over the tab 126b of the deployment latch 126, the handle deployment cam 132 pushes out the latch release mechanism 138 and releases the deployment latch 126 from the latch release mechanism 138. The tab 126b of the deployment latch 126 slides under or along the handle deployment cam 132 until the tab 126b lines up with or aligns with the window 132a, and the tab 126b reseats with the window 132a to lock the handle deployment cam 132, with the handle 116 in the flush position.

The user depresses or pushes the handle 116 in toward the base portion 114 and the rear portion or surface of the handle 116 in turn pushes the deployment latch 126 to release the deployment cam 132 from the deployment latch 126. With the deployment latch 126 released from the deployment cam 132, the latch release mechanism 138 engages and locks the deployment latch 126 from re-engaging the handle deployment cam 132. The handle deployment cam 132 is then biased into engagement with the lever 116b of the handle 116 to push or urge the handle 116 outward from the base portion 114.

As the handle 116 moves toward the deployed position, the latch release mechanism 138 rides along a surface of the handle deployment cam 132. As the latch release mechanism 138 rides along the surface of the handle deployment cam 132 and the handle 116 approaches the deployed position, the latch release mechanism 138 lifts or moves relative to the handle deployment cam 132 and the deployment latch 126 to release the deployment latch 126.

When the user grasps the handle 116 and pulls or moves the handle 116 further beyond the deployed state, the lever 116b engages the cable pull cam 122 and pivots the cable pull cam 122 to release the latch mechanism of the door, such as via a cable/rod coupled to the latch mechanism. The toothed or geared relationship between the cable pull cam 122 and the handle deployment cam 132 causes the handle deployment cam 132 to pivot back toward the starting position as the cable pull cam 122 is pivoted to release the latch mechanism. Thus, the handle deployment cam 132 is reset and the deployment latch 126 engages the tab 132a of the handle deployment cam 132 to lock or secure the handle deployment cam 132. The handle 116 may then return to the flush position when released by the user.

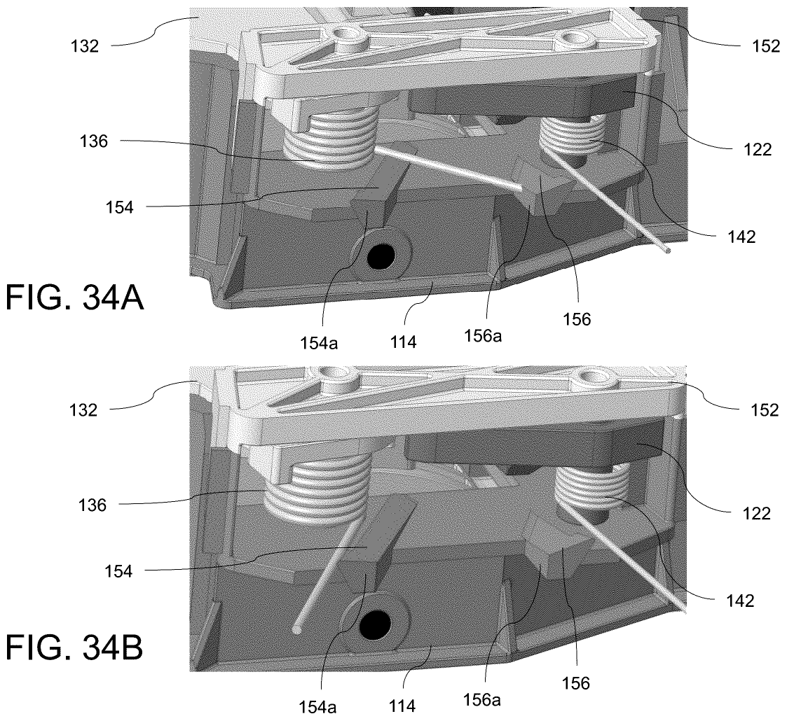

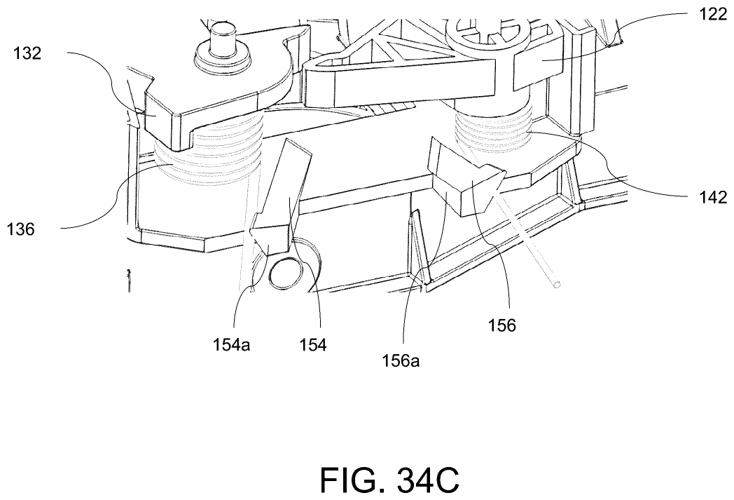

Referring to FIGS. 34A-34C, the handle assembly 110 may include a cover or housing portion 152 that attaches, such as snap attaches, at the base portion 114 such that the handle return cam 132 and the cable pull cam 122 are disposed between the base portion 114 and the cover portion 152. The respective pivot pins 124, 134 may extend between the base portion 114 and the cover portion 152 and through the respective handle return cam 132 and the cable pull cam 122 to pivotally attach the cams at the assembly. Before attachment of the cover portion 152, the handle return cam 132 and the cable pull cam 122 may be installed at the base portion 114 with the respective biasing members 136, 142 installed in an unwound or un-torqued state. That is, the biasing member 136 at the handle return cam 132 and the biasing member 142 at the cable pull cam 122 may be wound or torqued after installation at the base portion 114, with the base portion including engagement structure for securing or locking the respective biasing members in wound or torqued positions.

For example, the base portion 114 includes a first wedge or ramp 154 with a catch or surface 154a so that, with a first end of the biasing member 136 secured relative to the handle return cam 132, a second end of the biasing member 136 may be pivoted or moved along the ramp 154 to wind or torque the biasing member 136 and then engage the catch 154a to secure the second end of the biasing member 136 and maintain the biasing member 136 in the torqued state. Similarly, the base portion 114 includes a second wedge or ramp 156 with a catch or surface 156a so that, with a first end of the biasing member 142 secured relative to the cable pull cam 122, a second end of the biasing member 142 may be pivoted or moved along the ramp 156 to wind or torque the biasing member 142 and then engage the catch 156a to secure the second end of the biasing member 142 and maintain the biasing member 142 in the torqued state.

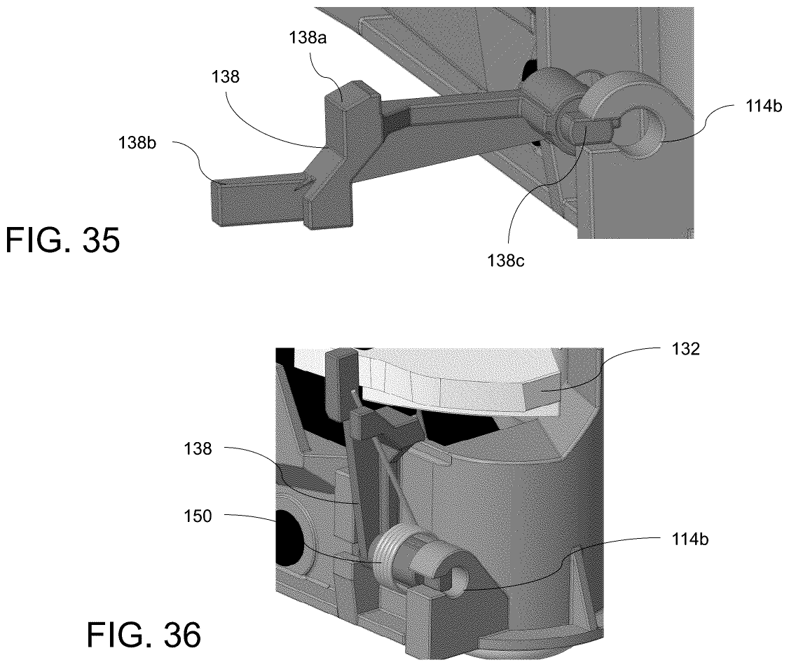

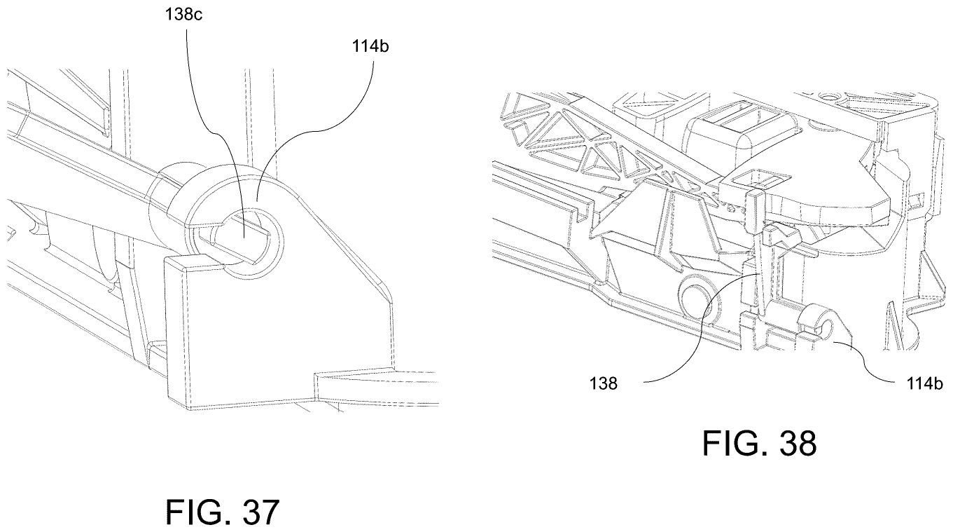

Further, and such as shown in FIGS. 35-38, the latch release mechanism 138 includes a tab or keyed portion 138c that is inserted into a circular journal or pivot portion 114b of the base portion 114 to pivotally attach the latch release mechanism 138 at the base portion 114. The tab 138c is inserted through a keyed slot in the circular journal 114b, with the biasing member 150 disposed at the latch release mechanism 138 in an unwound or un-torqued state. As the latch release mechanism 138 is pivoted toward engagement with the surface 132d of the handle return cam 132, the biasing member 150 is wound and the tab 138c pivots along the circular journal 114b relative to the keyed slot to preclude the latch release mechanism 138 from pulling out of the circular journal 114b.

That is, the assembly of one or more spring mechanisms of the assembly allows for winding or torqueing of the spring after assembly. For example, the cam and spring sub-assembly for the handle return cam 132 and/or the cable pull cam 122 are loaded onto the base portion 114 in an unwound state. Once the handle return cam 132, the cable pull cam 122 and the respective biasing members 124, 134 are loaded, the bracket closeout or cover portion 152 may be snapped over the respective cams. With the first end of the torsion spring 136 secured or fixed relative to the handle return cam 132, the second end of the torsion spring 136 may be positioned at a base or first end of the first ramp 154 and moved or wound (e.g., left or clockwise in FIG. 34A) along or up the first ramp or tab or wedge 154 of the base portion 114 to torque or apply tension via the torsion spring 136 between the base portion 114 and the handle return cam 132 and bias the handle return cam 132 toward the cable pull cam 122. Once the first end of the torsion spring 136 is wound or rotated far enough, the second end of the torsion spring 136 seats onto the catch or surface 154a of the wedge 154 to secure the ends of the torsion spring 136 in position relative to the base portion 114 and the handle return cam 132. The geometry of the catch 154a ensures that the spring 136 is not released. Similarly, with the first end of the torsion spring 142 secured or fixed relative to the cable pull cam 122, the second end of the torsion spring 142 may be positioned at a base or first end of the second ramp 156 and moved or wound (e.g., left or clockwise in FIG. 34A) along or up the second ramp or tab or wedge 156 of the base portion 114 to engage the catch or surface 156a of the wedge 156 when the torsion spring 142 is wound to provide the desired torque between the base portion 114 and the cable pull cam 122 to bias the cable pull cam 122 toward the handle return cam 132.

Further, the biasing member 150 disposed at the latch release mechanism 138 may be installed or attached with the latch release mechanism 138 at the base portion 114 in an unwound or un-torqued state. For example, the tab 138c of the latch release mechanism 138 is inserted into the base portion 114 through the keyed slot in the circular journal 114b of the base portion 114. With the latch release mechanism 138 rotated into its loaded position, the keyed slot and tab 138c prevent the journal 114b from allowing the release latch 138 or the biasing member 150 from being removed.

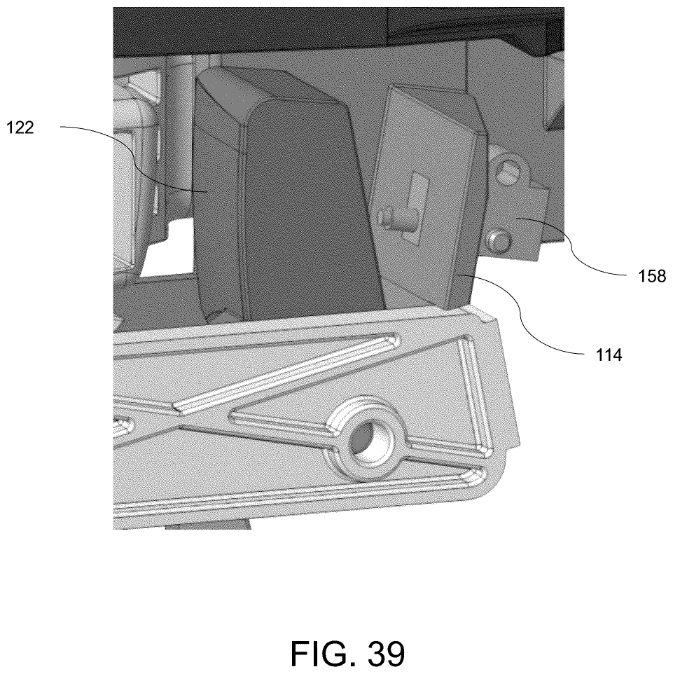

Optionally, and such as shown in FIGS. 39-42, the handle assembly may include an electronic latch mechanism that, when actuated, electronically releases the latch mechanism of the door. For example, a switch or plunger 158 may be disposed at the handle assembly so that, when the handle 116 is moved from the deployed position, the plunger 158 is compressed and activates the electronic latch mechanism to release the latch mechanism of the door. The switch or plunger 158 may be placed and designed so that a small amount of door handle 116 movement beyond the deployed position triggers the electronic latch. A benefit of this is that the door latch is released before the handle reaches its unlatched state when moved further beyond the deployed position by the user, so there is little to no delay for releasing the latch when the handle 116 is pulled.

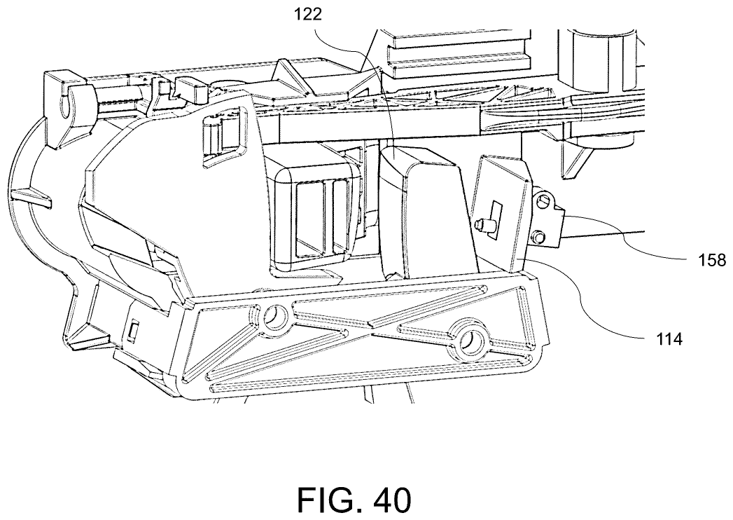

As shown in FIGS. 39 and 40, the plunger 158 may be disposed at the base portion 114 so that the plunger 158 is triggered by the cable pull cam 122 when the handle 116 is pulled and the lever 116b engages and pivots the cable pull cam 122 toward the plunger 158. Thus, the electronic latch mechanism may be triggered as the cable pull cam 122 releases the latch via the pull cable or pull rod or the electronic latch mechanism may be triggered just before the cable pull cam 122 releases the latch of the door.

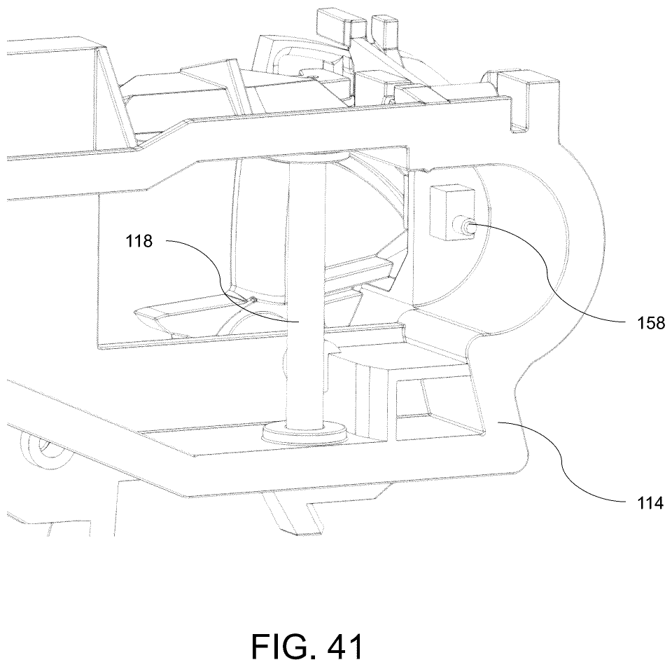

As shown in FIG. 41, the switch 158 may be triggered via engagement with the handle portion 116 by placing the switch 158 at the base portion 114 in front of the handle pivot pin 118. In other words, the switch 158 may be positioned at the base portion 114 and facing the rear surface of the handle portion 116. Thus, as the handle 116 is moved further beyond the deployed position, an end region of the handle 116 opposite the end grasped by the user is moved toward the base portion 114 to engage and activate the switch 158.

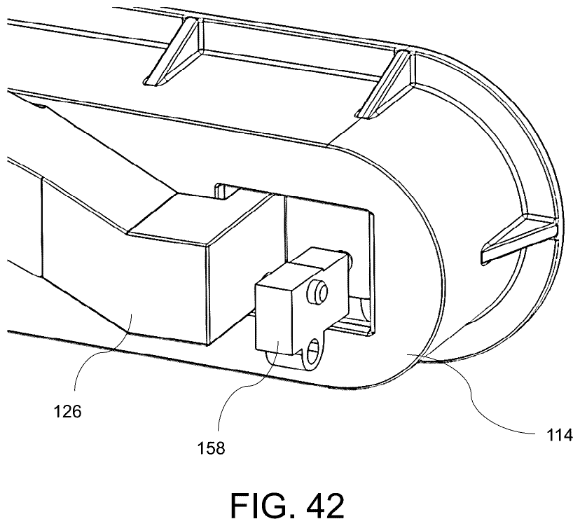

As shown in FIG. 42, the switch 158 may be triggered when the user depresses the handle 116 toward the base portion 114 to deploy the handle 116. For example, the switch 158 may be disposed at the base portion 114 and at or near the standoff 126a so that, when the handle portion 116 is depressed or compressed to deploy the handle portion 116, the handle 116 engages the switch 158 to release the door latch and engages the standoff 126a to disengage the deployment latch 126 and deploy the handle 116. A benefit of this is that the door latch is released before the handle 116 reaches its deployed state, so there is no delay when the handle 116 is pulled and the handle 116 may be pulled to open the door.

Although shown as a strap type handle, the handle assembly may comprise any suitable type of vehicle door handle assembly, such as a paddle type vehicle door handle assembly (having a paddle or handle portion that is pivotable about a generally horizontal pivot axis to open the vehicle door) and/or such as a handle assembly of the types described in U.S. Pat. Nos. 6,349,450; 6,550,103 and/or 6,907,643, which are hereby incorporated herein by reference in their entireties) or other type of vehicle door handle assembly. Optionally, the door handle assembly may include a soft touch handle portion, such as utilizing the principles described in U.S. Pat. Nos. 6,349,450; 6,550,103 and/or 6,907,643, incorporated above.

Although shown and described as being a generally horizontally oriented handle portion that moves laterally from the side of the vehicle, it is envisioned that the handle of the extendable flush door handle assembly may be oriented in any manner. For example, the handle may be oriented so that it is either vertical, horizontal, or diagonal with respect to the ground. Also, although shown and described as an exterior door handle for opening a side door or rear door or lift gate of a vehicle from exterior the vehicle, it is envisioned that the extendable flush door handle assembly may be suitable for use as an interior handle for opening a side door or rear door or liftgate of a vehicle from inside the vehicle.

Optionally, the door handle assembly may include a light module or lighting element, such as for illuminating the door handle portion or the inner portion of the door handle portion, so that the user can readily see and discern the door handle when approaching the vehicle in low lighting conditions. The lighting element may comprise a strip light or pocket light or the like, and the door handle assembly may include a ground illumination light and/or other light or lighting element, such as a projection light or the like, such as by utilizing aspects of the door handle assemblies and lighting systems described in U.S. Pat. Nos. 8,786,401; 8,801,245; 5,371,659; 5,497,305; 5,669,699; 5,823,654; 6,349,450; and/or 6,550,103, which are hereby incorporated herein by reference in their entireties.

Optionally, the door handle assembly or module may include or may be associated with an antenna for receiving signals from or communicating with a remote device. For example, the antenna (such as, for example, an antenna of the types described in U.S. Pat. No. 6,977,619 and/or U.S. Publication No. US-2010-0007463, which are hereby incorporated herein by reference in their entireties) may communicate a signal to the door locking system via a wire connection or the like, or wirelessly, such as via a radio frequency signal or via an infrared signal or via other wireless signaling means. For example, the handle assembly may include an antenna or sensor (such as an antenna and/or capacitive sensor) at the handle portion and/or may include a passive entry device or element. The antenna or sensor and/or passive entry device may receive a signal from a transmitting device (such as from a key fob or the like carried by the driver of the vehicle) and/or may sense or detect the presence of or proximity of a person or person's hand at or near the door handle, and may generate an output signal indicative of such detection. The actuator may be responsive to the antenna and/or sensor and/or device to impart an outward movement of the door handle portion so that the user can grasp the handle portion to open the door of the vehicle.

Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408 and/or 6,477,464, which are all hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208 and/or 6,568,839, all of which are hereby incorporated herein by reference in their entireties), or the vehicle ignition, or any other desired system.

Changes and modifications to the specifically described embodiments may be carried out without departing from the principles of the present invention, which is intended to be limited only by the scope of the appended claims as interpreted according to the principles of patent law.

1. A vehicular exterior door handle assembly, the vehicular exterior door handle assembly comprising:
a base portion configured to mount at a door of a vehicle equipped with the vehicular exterior door handle assembly;
a handle portion including a grasping portion;
wherein the handle portion is movable relative to the base portion between (i) a recessed position, where the grasping portion of the handle portion is at least partially recessed at the base portion, and (ii) a deployed position, where the grasping portion of the handle portion protrudes outward from the base portion so as to be graspable by a user;
a deployment mechanism coupled to the handle portion and operable to move the handle portion between the recessed position and the deployed position;
wherein the deployment mechanism comprises a handle return cam that is biased in a first direction relative to the base portion, and wherein the deployment mechanism, with the handle portion in the recessed position, mechanically secures the handle return cam relative to the base portion;
wherein, with the base portion mounted at the door of the vehicle, the handle portion, when in the recessed position, is manually movable beyond the recessed position and away from the deployed position to actuate the deployment mechanism;
wherein the deployment mechanism, responsive to the handle portion being moved beyond the recessed position and away from the deployed position, releases the handle return cam to allow the handle return cam to move in the first direction to move the handle portion toward the deployed position;
wherein, with the base portion mounted at the door of the vehicle, the handle portion, when in the deployed position, is manually movable beyond the deployed position and away from the recessed position to actuate a latch mechanism of the door; and
wherein the deployment mechanism, with the handle portion in the deployed position and responsive to the handle portion being moved beyond the deployed position and away from the recessed position, operates to move the handle portion toward the recessed position.

2. The vehicular exterior door handle assembly of claim 1, wherein the deployment mechanism further comprises a deployment latch that, with the handle portion in the recessed position, engages the handle return cam to mechanically secure the handle return cam relative to the base portion, and wherein the handle return cam is pivotally attached to the base portion, and wherein the handle return cam, with the handle portion in the recessed position and responsive to being released, pivots in the first direction to move the handle portion toward the deployed position.

3. The vehicular exterior door handle assembly of claim 2, wherein the deployment latch, with the handle portion in the recessed position and responsive to the handle portion being moved beyond the recessed position and away from the deployed position, disengages from the handle return cam to release the handle return cam and allow pivotal movement of the handle return cam in the first direction.

4. The vehicular exterior door handle assembly of claim 3, wherein the deployment latch, responsive to disengaging from the handle return cam, engages a latch catch coupled to the base portion, and wherein the deployment latch, while engaging the latch catch, is spaced from the handle return cam.

5. The vehicular exterior door handle assembly of claim 4, wherein the latch catch moves along a surface of the handle return cam, and wherein the latch catch, as the handle return cam pivots relative to the base portion, is configured to move into and out of engagement with the deployment latch according to movement of the latch catch along the surface of the handle return cam.

6. The vehicular exterior door handle assembly of claim 5, wherein the latch catch is biased toward engagement with the surface of the handle return cam.

7. The vehicular exterior door handle assembly of claim 2, wherein the handle return cam, with the handle portion in the deployed position and responsive to the handle portion being moved beyond the deployed position and away from the recessed position, pivots in a second direction opposite the first direction and is engaged by the deployment latch to mechanically secure the handle return cam relative to the base portion.

8. The vehicular exterior door handle assembly of claim 7, wherein the latch mechanism of the door is coupled to a cable pull cam, and wherein, with the base portion mounted at the door of the vehicle, the handle portion, when in the deployed position and when moved beyond the deployed position and away from the recessed position, engages the cable pull cam and imparts pivotal movement of the cable pull cam in the first direction to actuate the latch mechanism of the door.

9. The vehicular exterior door handle assembly of claim 8, wherein, with the base portion mounted at the door of the vehicle, the cable pull cam is in geared engagement with the handle return cam, and wherein the cable pull cam, as the cable pull cam pivots in the first direction, imparts pivotal movement of the handle return cam in the second direction.

10. The vehicular exterior door handle assembly of claim 7, wherein the deployment latch, with the handle portion in the deployed position and responsive to the handle portion being moved beyond the deployed position and away from the recessed position, and with the handle return cam pivoting in the second direction, engages the handle return cam to limit pivotal movement of the handle return cam in the first direction.

11. The vehicular exterior door handle assembly of claim 10, wherein the handle portion is biased from the deployed position toward the recessed position, and wherein the handle portion, with the deployment latch engaging the handle return cam, and responsive to the handle portion being moved beyond the deployed position and away from the recessed position, and responsive to the handle portion being released after moving beyond the deployed position and away from the recessed position, moves toward the recessed position.

12. The vehicular exterior door handle assembly of claim 1, wherein the deployment mechanism is mechanically operable to move the handle portion between the recessed position and the deployed position without an electrical power source.

13. The vehicular exterior door handle assembly of claim 1, wherein, with the base portion mounted at the door of the vehicle, an outer surface of the handle portion, with the handle portion in the recessed position, is flush with an outer surface of the door of the vehicle.

14. The vehicular exterior door handle assembly of claim 1, wherein the handle portion comprises (i) a first end that is pivotally attached to the base portion, and (ii) a second end opposite the first end that comprises the grasping portion, and wherein the handle portion, when moved between the recessed position and the deployed position, pivots relative to the base portion between the recessed position and the deployed position.

15. The vehicular exterior door handle assembly of claim 1, wherein an electronic switch is disposed at the base portion, and wherein, with the base portion mounted at the door of the vehicle, the electronic switch, when engaged by the handle portion or part of the deployment mechanism, is actuated to electronically actuate the latch mechanism of the door.

16. The vehicular exterior door handle assembly of claim 15, wherein the electronic switch is engaged by the handle portion when the handle portion is moved beyond the deployed position and away from the recessed position.

17. The vehicular exterior door handle assembly of claim 15, wherein the electronic switch is engaged by part of the deployment mechanism when the handle portion is moved beyond the deployed position and away from the recessed position.

18. The vehicular exterior door handle assembly of claim 15, wherein the electronic switch is engaged by the handle portion when the handle portion is moved beyond the recessed position and away from the deployed position.

19. A vehicular exterior door handle assembly, the vehicular exterior door handle assembly comprising:
a base portion configured to mount at a door of a vehicle equipped with the vehicular exterior door handle assembly;
a handle portion including a grasping portion;
wherein the handle portion is movable relative to the base portion between (i) a recessed position, where the grasping portion of the handle portion is at least partially recessed at the base portion, and (ii) a deployed position, where the grasping portion of the handle portion protrudes outward from the base portion so as to be graspable by a user;
a deployment mechanism coupled to the handle portion and operable to move the handle portion between the recessed position and the deployed position;
wherein the deployment mechanism comprises (i) a handle return cam that is pivotally attached to the base portion and biased in a first direction relative to the base portion and (ii) a deployment latch that, with the handle portion in the recessed position, engages the handle return cam to mechanically secure the handle return cam relative to the base portion;
wherein, with the base portion mounted at the door of the vehicle, the handle portion, when in the recessed position, is manually movable beyond the recessed position and away from the deployed position to actuate the deployment mechanism;
wherein the deployment latch, responsive to the handle portion being moved beyond the recessed position and away from the deployed position, disengages from the handle return cam to release the handle return cam and allow pivotal movement of the handle return cam in the first direction to move the handle portion toward the deployed position;
wherein, with the base portion mounted at the door of the vehicle, the handle portion, when in the deployed position, is manually movable beyond the deployed position and away from the recessed position to actuate a latch mechanism of the door;
wherein the deployment mechanism, with the handle portion in the deployed position and responsive to the handle portion being moved beyond the deployed position and away from the recessed position, operates to move the handle portion toward the recessed position; and
wherein the handle return cam, with the handle portion in the deployed position and responsive to the handle portion being moved beyond the deployed position and away from the recessed position, pivots in a second direction opposite the first direction and is engaged by the deployment latch to mechanically secure the handle return cam relative to the base portion.

20. The vehicular exterior door handle assembly of claim 19, wherein the deployment latch, responsive to disengaging from the handle return cam, engages a latch catch coupled to the base portion, and wherein the deployment latch, while engaging the latch catch, is spaced from the handle return cam.

21. The vehicular exterior door handle assembly of claim 19, wherein the latch mechanism of the door is coupled to a cable pull cam, and wherein, with the base portion mounted at the door of the vehicle, the handle portion, when in the deployed position and when moved beyond the deployed position and away from the recessed position, engages the cable pull cam and imparts pivotal movement of the cable pull cam in the first direction to actuate the latch mechanism of the door.

22. The vehicular exterior door handle assembly of claim 21, wherein, with the base portion mounted at the door of the vehicle, the cable pull cam is in geared engagement with the handle return cam, and wherein the cable pull cam, as the cable pull cam pivots in the first direction, imparts pivotal movement of the handle return cam in the second direction.

23. The vehicular exterior door handle assembly of claim 19, wherein the deployment latch, with the handle portion in the deployed position and responsive to the handle portion being moved beyond the deployed position and away from the recessed position, and with the handle return cam pivoting in the second direction, engages the handle return cam to limit pivotal movement of the handle return cam in the first direction.

24. The vehicular exterior door handle assembly of claim 23, wherein the handle portion is biased from the deployed position toward the recessed position, and wherein the handle portion, with the deployment latch engaging the handle return cam, and responsive to the handle portion being moved beyond the deployed position and away from the recessed position, and responsive to the handle portion being released after moving beyond the deployed position and away from the recessed position, moves toward the recessed position.

25. A vehicular exterior door handle assembly, the vehicular exterior door handle assembly comprising:
a base portion configured to mount at a door of a vehicle equipped with the vehicular exterior door handle assembly;
a handle portion including a grasping portion;
wherein the handle portion is movable relative to the base portion between (i) a recessed position, where the grasping portion of the handle portion is at least partially recessed at the base portion, and (ii) a deployed position, where the grasping portion of the handle portion protrudes outward from the base portion so as to be graspable by a user;
wherein the handle portion comprises (i) a first end that is pivotally attached to the base portion, and (ii) a second end opposite the first end that comprises the grasping portion, and wherein the handle portion, when moved between the recessed position and the deployed position, pivots relative to the base portion between the recessed position and the deployed position;
a deployment mechanism coupled to the handle portion and operable to move the handle portion between the recessed position and the deployed position;
wherein the deployment mechanism comprises a handle return cam that is biased in a first direction relative to the base portion, and wherein the deployment mechanism, with the handle portion in the recessed position, mechanically secures the handle return cam relative to the base portion;
wherein, with the base portion mounted at the door of the vehicle, the handle portion, when in the recessed position, is manually movable beyond the recessed position and away from the deployed position to actuate the deployment mechanism;
wherein the deployment mechanism, responsive to the handle portion being moved beyond the recessed position and away from the deployed position, releases the handle return cam to allow the handle return cam to move in the first direction to move the handle portion toward the deployed position;
wherein, with the base portion mounted at the door of the vehicle, the handle portion, when in the deployed position, is manually movable beyond the deployed position and away from the recessed position to actuate a latch mechanism of the door;
wherein the deployment mechanism, with the handle portion in the deployed position and responsive to the handle portion being moved beyond the deployed position and away from the recessed position, operates to move the handle portion toward the recessed position; and
wherein an electronic switch is disposed at the base portion, and wherein, with the base portion mounted at the door of the vehicle, the electronic switch, when engaged by the handle portion or part of the deployment mechanism, is actuated to electronically actuate the latch mechanism of the door.

26. The vehicular exterior door handle assembly of claim 25, wherein the deployment mechanism further comprises a deployment latch that, with the handle portion in the recessed position, engages the handle return cam to mechanically secure the handle return cam relative to the base portion, and wherein the handle return cam is pivotally attached to the base portion, and wherein the handle return cam, with the handle portion in the recessed position and responsive to being released, pivots in the first direction to move the handle portion toward the deployed position.

27. The vehicular exterior door handle assembly of claim 26, wherein the handle return cam, with the handle portion in the deployed position and responsive to the handle portion being moved beyond the deployed position and away from the recessed position, pivots in a second direction opposite the first direction and is engaged by the deployment latch to mechanically secure the handle return cam relative to the base portion.

28. The vehicular exterior door handle assembly of claim 25, wherein the electronic switch is engaged by the handle portion when the handle portion is moved beyond the deployed position and away from the recessed position.

29. The vehicular exterior door handle assembly of claim 25, wherein the electronic switch is engaged by part of the deployment mechanism when the handle portion is moved beyond the deployed position and away from the recessed position.

30. The vehicular exterior door handle assembly of claim 25, wherein the electronic switch is engaged by the handle portion when the handle portion is moved beyond the recessed position and away from the deployed position.
